(19) United States
(12) Patent Application Publication
(10) Pub. No.: US 2024/0061180 A1
(43) Pub. Date: Feb. 22, 2024

(54) WAVELENGTH DIVISION MULTIPLEXING/DEMULTIPLEXING DEVICES

(71) Applicant: CommScope Technologies LLC, Hickory, NC (US)

(72) Inventors: Saurav KUMAR, Gent (BE); Jan WATTÉ, Grimbergen (BE); Cristina LERMA ARCE, Gentbrugge (BE); Vivek PANAPAKKAM VENKATESAN, Leuven (BE); Jill Anne MALECHA, New Prague, MN (US)

(73) Assignee: CommScope Technologies LLC, Hickory, NC (US)

(21) Appl. No.: 18/256,015

(22) PCT Filed: Dec. 3, 2021
(86) PCT No.: PCT/US2021/061880

§ 371 Date: Jun. 5, 2023

Related U.S. Application Data
(60) Provisional application No. 63/121,710, filed on Dec. 4, 2020.
(60) Provisional application No. 63/154,421, filed on Feb. 26, 2021.
(60) Provisional application No. 63/166,650, filed on Mar. 26, 2021.
(60) Provisional application No. 63/230,505, filed on Aug. 6, 2021.

(51) Int. Cl. G02B 6/293

(52) U.S. Cl. CPC G02B 6/29361; G02B 6/2938

(57) ABSTRACT

Integrated WDM mux/demux devices are disclosed. Some embodiments are directed to an in-line WDM mux/demux device formed with a substrate and a common port at a first side of the substrate and a plurality of separated wavelength ports at a second side of the substrate. The first side of the substrate is free of separated wavelength ports. Other embodiments are directed to a WDM mux/demux device in which a linear variable filter is disposed in the substrate for separating the signals in different channels. In other embodiments, the filter or filters are sandwiched between the edges of adjacent substrates, such that light propagating along a waveguide in one of the substrates is transmitted through the filter to a waveguide in the second substrate. The adjacent substrates may be mounted to a base substrate.

### PRIORITY CLAIM

This application is being filed on Dec. 3, 2021 as a PCT International Patent Application and claims the benefit of U.S. Patent Application Ser. No. 63/121,710, filed on Dec. 4, 2020, and claims the benefit of U.S. Patent Application Ser. No. 63/154,421, filed on Feb. 26, 2021 and claims the benefit of U.S. Patent Application Ser. No. 63/166,650, filed on Mar. 26, 2021 and claims the benefit U.S. Patent Application Ser. No. 63/230,505, filed on Aug. 6, 2021, the disclosures of which are incorporated herein by reference in their entireties.

### FIELD OF THE DISCLOSURE

The invention relates to optical devices for wavelength division multiplexing, and more particularly to integrated optical devices used for wavelength division multiplexing.

### BACKGROUND

One of the most commonly used approaches to increasing the data handling capacity of a fiber network is to use wavelength division multiplexing (WDM), in which an optical fiber carries multiple optical signals, each signal at its own, unique wavelength. This requires the use of WDM components for combining (multiplexing) or separating (demultiplexing) the signals at their respective wavelengths.

In conventional multichannel WDM multiplexing/demultiplexing (mux/demux) devices, a multiplexed optical signal, containing components at multiple wavelengths, propagates in free space from a common fiber along a cascade of wavelength selective filters, where each filter in the cascade separates out a component at a single wavelength. This arrangement requires the use of lenses to collimate the light emitted by the common fiber and to focus the light transmitted by each filter into the individual channel fibers. The lenses and filters are mounted on a substrate, often formed of a ceramic or metal material. In some cases, the optical fibers are pigtailed to their respective lenses, for example where the lens is a gradient index (GRIN) lens. In an alternate arrangement, the light may propagate along fibers between the filters: this approach also requires the use of multiple lenses. Assembly of these devices requires expensive pick and place mechanisms.

A filter-based WDM multiplexer/demultiplexer (mux/demux) has recently been proposed, in which the device is implemented on an optical chip. In this case, the optical path between filters is a guided optical path along a waveguide, rather than through free space. Each filter is placed in a slot that lies across a waveguide to reflectively select out a component at a specific wavelength into a single wavelength waveguide, and to transmit the remaining combined signal to the next filter. This approach reduces the need for the costly pick and place mechanisms used in the manufacture of the free-space propagation WDM mux/demux, since the filters are aligned by the etched slots in which they are placed.

The thin film filters used in the WDM mux/demux are generally made as thin as possible, typically around 20 μm, so as to reduce the distance that the optical signals propagate in free space between waveguides. Consequently, the slots to be etched in the substrate should also be thin, a little wider than the thin film filter, but deep enough to allow the filter to be dropped into place and be maintained in a vertical orientation. Slots of these dimensions are difficult to etch, even using advanced etching techniques like deep reactive ion etching (DRIE). Another approach to embedding a filter in an optical chip is to use a trench sliced across the chip using a dicing saw with a thin blade, around 20 μm wide. Because the sidewalls of the trench are inaccessible to polishing, the sidewalls, through which the optical signals have to pass, are left with the surface roughness that results from the cutting process. Since the trench walls are not accessible for polishing, this may lead to increased losses arising from the rough surface, for example by incomplete filling of the space between the filter and the trench wall with adhesive.

There is a need, therefore, to reduce the complexity of WDM devices, for example, for WDM devices that use fewer components and that use simpler manufacturing techniques, for example reducing the number of filter elements that are to be used in the WDM mux/demux. There is also a need to develop techniques that avoid the need to etch slots for wavelength selective filters, and which can produce smooth edges to the substrates, thus ensuring high quality optical interfaces between the side surface of the chip and the thin film filter. These improvements will lead to reduced manufacturing costs and to improved manufacturing yields.

It has also been found that currently available WDM mux/demux devices have a geometry that is less than optimal in some situations, because of the way in which the fibers are connected to the device. For example, butt-geometry devices are commonplace, in which all the fibers, both the common fiber and the individual channel fibers, are arranged to be connected to one side of the device. In some situations, however, it is not convenient to for the common fiber to approach the device from the same side as the individual channel fibers. There is, therefore, a need to produce WDM mux/demux devices that permit the common fiber to attach at a different side of the device the individual channel fibers. Such devices may be integrated devices using waveguides for propagation of the optical signals, or may be allow for propagation of the optical signals in free space.

### SUMMARY OF THE INVENTION

The present invention relates generally to an in-line WDM mux/demux device. The device has a substrate and a common port at a first side of the substrate. There is a plurality of separated wavelength ports at a second side of the substrate, the first side of the substrate being free of separated wavelength ports. A first optical path lies between the common port and a first of the plurality of separated wavelength ports. The first optical path passes through a filter, mounted to the substrate, transmissive at a first wavelength. A second optical path lies between the common port and a second of the plurality of separated wavelength ports. The second optical path is reflected at the filter transmissive at the first wavelength, reflected at a broadband reflector and transmitted through a filter, mounted to the substrate, transmissive at a second wavelength different from the first wavelength. In some embodiments the first and second optical paths are waveguided, in other embodiments they are free space optical paths.

Another embodiment of the invention is directed to an in-line WDM mux/demux device that includes a substrate having a common waveguide, a first end of the common waveguide being located at a first edge of the substrate. A first wavelength selective filter is on the substrate at a second end of the common waveguide. The common waveguide is on a first side of the first wavelength selective filter. The first wavelength selective filter is transmissive at a first wavelength and reflective at at least a second wavelength. A first selected wavelength waveguide is on the substrate, located on a second side of the first selective filter and aligned to receive light at the first wavelength, transmitted through the first wavelength selective filter from the common waveguide, into a first end. The first selected wavelength waveguide has a second end at a second edge of the substrate. A first waveguide is disposed on the substrate between the first wavelength selective filter and a reflector, to transmit light reflected from the common waveguide by the first selective filter to the reflector. A second waveguide is disposed on the substrate between the reflector and a second wavelength selective filter to transmit light from the first waveguide that is reflected from the reflector to a second wavelength selective filter. The second wavelength selective filter is transmissive at the second wavelength, the second waveguide being on a first side of the second wavelength selective filter. A second selected wavelength waveguide is on the substrate, located on a second side of the second selective filter and aligned to receive light at the second wavelength, transmitted through the second wavelength selective filter from the second waveguide, into a first end. The second selected wavelength waveguide has a second end at the second edge of the substrate. A normal to a reflecting surface of the reflector forms an angle φ relative to an axis of the common waveguide at the first end of the common waveguide.

Another embodiment of the invention is directed to an optical device that has a first substrate having a first edge. A first waveguide in the first substrate terminates at the first edge of the first substrate and is aligned at a first angle to the first edge. A second waveguide in the first substrate terminates at the first edge of the first substrate and is aligned at a second angle to the first edge, the second angle being different from the first angle. A second substrate has a second edge. A third waveguide in the second substrate terminates at the second edge of the second substrate and is aligned at a third angle to the second edge. The third waveguide is aligned to receive light from the first waveguide of the first substrate. A first wavelength selective filter is disposed between the first edge of the first substrate and the second edge of the second substrate so that light propagating between the first waveguide and the third waveguide passes through the first wavelength selective filter. The first and second substrates are held together by adhesive between the first edge and the second edge. The first wavelength selective filter either reflects light at a first wavelength from the first waveguide to the second waveguide or transmits light at the first wavelength from the first waveguide to the third waveguide.

Another embodiment of the invention is directed to an optical device that includes a first substrate having a first edge and a second substrate having a second edge. A wavelength selective filter unit is disposed in a gap between the first edge of the first substrate and the second edge of the second substrate. The wavelength selective filter unit comprises a first portion transmissive at a first wavelength and reflective at a second wavelength different from the first wavelength, and also comprises a second portion transmissive at the second wavelength.

Another embodiment of the invention is directed to a method of making an optical device. The method includes providing a first substrate having a first waveguide terminating proximate a first edge of the first substrate and a second waveguide terminating proximate the first edge, and providing a second substrate having a third waveguide terminating at a second edge of the second substrate. A wavelength selective filter unit is adhered between the first edge of the first substrate and the second edge of the second substrate. The first and second substrates are aligned relative to each other, with the wavelength selective filter between the first substrate and the second substrate, so that the third waveguide is disposed to receive light transmitted through the wavelength selective filter unit from the first waveguide. The second waveguide is disposed to receive light reflected by the first wavelength selective filter from the first waveguide. The first substrate, the second substrate, and the wavelength selective filter unit form a wavelength division multiplexed unit.

Another embodiment of the invention is directed to an optical device, comprising a substrate and a common waveguide on the substrate for carrying a common optical signal having components at different wavelengths. A first linear variable filter (LVF), having a transmission wavelength that is dependent on position along the first LVF, is mounted in a first gap of the substrate. The common waveguide has a first end proximate a first position on the first LVF that corresponds to transmission of light at a first wavelength λ1, through the LVF. A first waveguide on the substrate has a first end proximate the first position of the first LVF so that light propagating from the common waveguide and reflecting at the first position of the first LVF passes into the first waveguide. A reflecting element is disposed proximate a second end of the first waveguide. A second waveguide on the substrate has a first end disposed proximate the second end of the first waveguide to receive light from the second end of the first waveguide after reflecting from the reflecting element. The second waveguide has a second end disposed proximate a second position of the first LVF, the second position on the LVF corresponding to transmission of light at a second wavelength λ2, through the LVF. A first separated wavelength waveguide on the substrate has a first end proximate the first position on the first LVF, and is disposed on another side of the first LVF from the common waveguide to receive light at λ1 transmitted through the first LVF from the common waveguide. A second separated wavelength waveguide on the substrate has a first end proximate the second position on the first LVF, and is disposed on another side of the first LVF from the second waveguide to receive light at λ2 transmitted through the first LVF from the second waveguide.

Another embodiment of the invention is directed an optical device that has a substrate and a first linear variable filter (LVF) mounted in a gap in the substrate. The first LVF has a transmission wavelength that is dependent on position along the first LVF. A common waveguided optical path on the substrate guides a common optical signal having components at a plurality of wavelengths from an input of the substrate to a first position on the first LVF. A first separated wavelength waveguided optical path on the substrate to guide light transmitted through the first LVF at the first position on the first LVF to a first separated wavelength output. A first waveguided optical path on the substrate guides light reflected from the first position on the first LVF to a second position on the first LVF. A second separated wavelength waveguided optical path on the substrate guides light transmitted through the first LVF at the second position on the first LVF to a second separated wavelength output.

Another embodiment of the invention is directed to an optical device that has a substrate. A first linear variable filter (LVF), having a transmission wavelength that is dependent on position along the first LVF, is mounted in a first gap of the first substrate. The first LVF has a first face. A second LVF, having a transmission wavelength that is dependent on position along the second LVF, is mounted in a second gap of the substrate. The second LVF has a second face facing the first face of the first LVF. A common waveguided optical path on the substrate guides a common optical signal having components at a plurality of wavelengths from an input of the common waveguided optical path to be incident on the first face of the first LVF, at a first position on the first LVF. A first waveguide on the substrate has a first end disposed to receive light from the common waveguide that is reflected at the first face at the first position of the first LVF. The first waveguide has a second end proximate a first position on the second LVF. A second waveguide on the substrate has a first end disposed to receive light from the first waveguide that is reflected at the second face at the first position of the second LVF. The second waveguide has a second end proximate a second position on the first LVF.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an optical communications system that uses a wavelength division multiplexing (WDM) multiplexer/demultiplexer (mux/demux);

FIG. 2A schematically illustrates how wavelength components of a WDM signal may be treated separately, according to an embodiment of the invention;

FIG. 2B schematically illustrates how wavelength components of a WDM signal may be treated in separate groups, according to an embodiment of the present invention;

FIG. 3 schematically illustrates a WDM mux/demux formed with a wavelength selective filter disposed in a gap between two waveguiding substrates, according to an embodiment of the present invention;

FIG. 4 schematically illustrates the WDM mux/demux of FIG. 3, with fiber connections, according to an embodiment of the present invention;

FIGS. 5A-5C schematically illustrate steps in the fabrication of the WDM mux/demux of FIG. 3, according to an embodiment of the present invention;

FIG. 6A schematically illustrates parabolic waveguide expansion regions used in an embodiment of a WDM mux/demux device according to the present invention;

FIG. 6B schematically illustrates linear waveguide expansion regions used in an embodiment of a WDM mux/demux device according to the present invention;

FIGS. 7A-7D schematically illustrate different physical configurations of a four-channel WDM mux/demux device;

FIG. 8A schematically illustrates a plan view of an integrated waveguide, four-channel WDM mux/demux device according to an embodiment of the present invention;

FIG. 8B schematically illustrates a side view of an embodiment of the integrated waveguide, four channel WDM mux/demux device of FIG. 8A, according to the present invention;

FIG. 8C schematically illustrates a side view of another embodiment of the integrated waveguide, four channel WDM mux/demux device of FIG. 8A, according to the present invention;

FIG. 9 schematically illustrates a plan view of an integrated waveguide, four-channel WDM mux/demux device according to another embodiment of the present invention;

FIG. 10 schematically illustrates another embodiment of a four channel integrated, in-line WDM mux/demux device, according to the present invention;

FIG. 11A schematically illustrates another embodiment of a four channel integrated, in-line WDM mux/demux device, according to the present invention;

FIG. 11B schematically illustrates an embodiment of a wavelength selective filter unit, having individual filters mounted on a substrate, that may be used in a WDM mux/demux device according to an embodiment of the present invention;

FIG. 11C schematically illustrates another embodiment of a wavelength selective filter unit, using a linear variable filter, that may be used in a WDM mux/demux device according to an embodiment of the present invention;

FIGS. 12A-12F schematically illustrate steps in manufacturing the linear variable filter of FIG. 11C;

FIG. 12G schematically illustrates a cross-sectional view through another embodiment of a linear variable filter;

FIG. 13A schematically illustrates part of a WDM mux/demux device in which the variable linear filter is disposed within a well formed in the substrate, according to an embodiment of the present invention;

FIG. 13B schematically illustrates a side cross-sectional view of how a variable linear filter may be mounted in a well formed in a substrate of a WDM mux/demux device according to an embodiment of the present invention;

FIGS. 14A and 14B schematically illustrate top and side views respectively of a WDM mux/demux device formed with a linearly variable wavelength selective filter disposed between two substrate sections, according to an embodiment of the present invention;

FIG. 15 schematically illustrates an embodiment of an eight channel, in-line integrated WDM mux/demux device, according to another embodiment of the present invention;

FIG. 16 schematically illustrates a top view of an embodiment of an eight channel integrated WDM mux/demux device in a hybrid configuration, formed with two linearly variable wavelength selective filters, according to an embodiment of the present invention; and

FIG. 17 schematically illustrates a four channel, in-line WDM mux/demux device using bulk components, according to another embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to optical devices for wavelength division multiplexing (WDM) that provide increased operational capabilities with reduced manufacturing costs. In some embodiments, the WDM devices have an in-line geometry, having a common input/output on one side of the device and individual wavelength (channel) or wavelength group inputs/outputs on a different side of the device. In other embodiments, the WDM devices use a unitary filter structure for covering a range of wavelengths. In other embodiments, the integrated structure is based on one or more filters disposed between edges of sub-substrates.

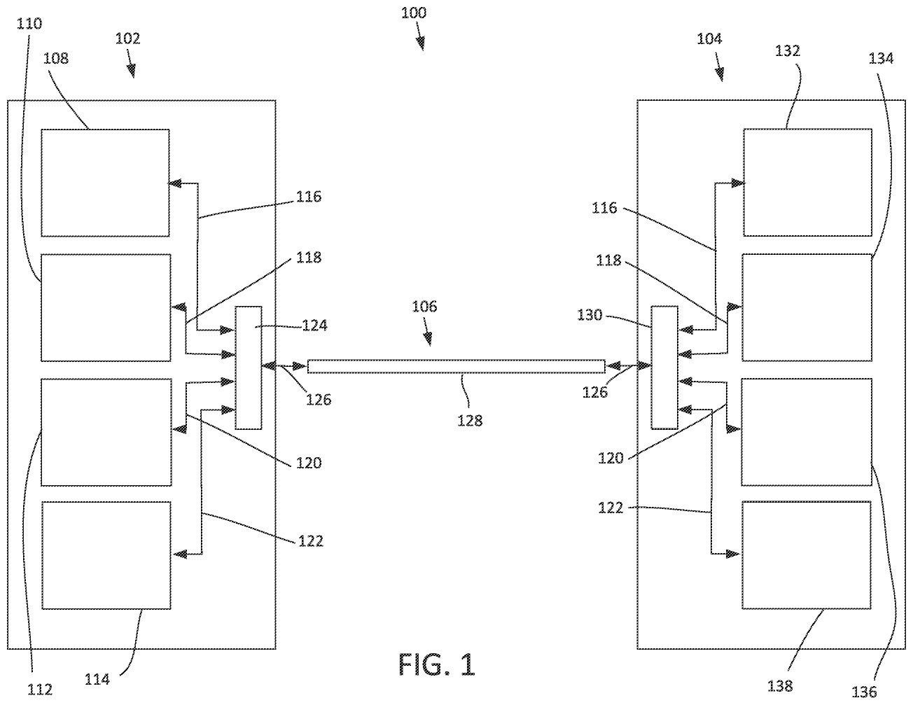

FIG. 1 schematically illustrates an embodiment of an optical communications system 100 that uses wavelength division multiplexing (WDM) to increase the data handling capacity of an optical fiber. The optical communication system 100 generally has a transmitter portion 102, a receiver portion 104, and an optical fiber portion 106. The optical fiber portion 106 is coupled between the transmitter portion 102 and the receiver portion 104 for transmitting an optical signal from the transmitter portion 102 to the receiver portion 104.

Optical signals at different wavelengths are generated within the transmitter portion 102 and are combined into the optical fiber 128 of the optical fiber portion 106 and are transmitted to the receiver portion 104, where the signals that propagated along the fiber 128 are spatially separated and directed to respective detectors. The illustrated embodiment shows an optical communication system 100 that multiplexes signals at four different wavelengths, although it will be appreciated that optical communications systems may multiplex different numbers of signals, e.g. two, eight, twelve, sixteen etc.

The transmitter portion 102 may include multiple optical transmitter units 108, 110, 112, 114 producing respective optical signals 116, 118, 120, 122 at different wavelengths λ1, λ2, λ3, λ4. It will be appreciated that the optical signal at each wavelength may comprise optical power spread over a band of wavelengths, however, each band of wavelengths is separated from the others. The wavelengths λ1, λ2, λ3, λ4 are contained within their respective bands of wavelengths and may constitute the center wavelength of their respective bands of wavelengths. Each optical transmitter unit 108, 110, 112, 114 may contain one or more light sources, for example lasers, for generating the respective optical signals, along with elements for modulating the light emitted by the light sources, for imposing information on the light, along with beam handling optics to direct the generated light beams along a desired path, for example out of the transmitter unit 108, 110, 112, 114 via a respective optical fiber.

The optical communication system 100 may operate at any useful wavelength for optical communications, for example in the range 800-950 nm, or over other wavelength ranges, such as 1250-1350 nm, 1500-1600 nm, or 1600-1650 nm. The signals 116, 118, 120, 122 are coupled to the optical fiber portion 106 via a WDM multiplexer/demultiplexer (“mux/demux”) unit 124, that directs the optical signals 116, 118, 120, 122 along the core of the fiber 128. A WDM mux/demux unit is an optical device that, for light traveling in one direction, combines two or more spatially separated optical signals at different wavelengths into a single fiber and, for light propagating in the opposite direction, splits light from a single fiber into two or more spatially separated optical signals at different wavelengths. The optical signals 116, 118, 120, 122 may be delivered to the mux/demux unit 124 via respective fibers from their respective transmitter units 108, 110, 112, 114 (not shown).

The combined signal 126 from the WDM mux/demux unit 124 contains components at each of the wavelengths of the signals that were combined in the WDM mux/demux 124 unit and is transmitted into the optical fiber 128. The combined signal 126 propagates along the optical fiber portion 106 to the receiver portion 104, where it is separated by a second WDM mux/demux unit 130 into the original optical signals 116, 118, 120, 122. The first optical signal 116, at wavelength λ1, is directed to the first receiver unit 132. The second optical signal 118, at wavelength λ2, is directed to the second receiver unit 134. The third optical signal 120, at wavelength λ3, is directed to the third receiver unit 136, and the fourth optical signal 122, at wavelength λ4, is directed to the fourth receiver unit 138. Each receiver unit 132, 134, 136, 138 includes one or more optical detectors, such as photodiodes or the like, for detecting the received optical signals 116, 118, 120, 122, along with beam handling optics, such as optical fibers, to direct the optical signals to the detectors.

In many optical communications systems there are optical signals propagating in both directions along an optical fiber. This possibility is indicated in FIG. 1, where the optical signals 116, 118, 120, 122 are designated with double-headed arrows. In such a case, the transmitter units 108, 110, 112, 114 and receiver units 132, 134, 136, 138 may be transceiver units that generate and receive signals at different wavelengths. In other embodiments, there may be a separate transmitter unit and receiver unit for a signal at each end of the optical fiber portion 106. In other embodiments still, there may be one or more optical circulators to separate transmitted and received signals at an end of the system 100. In such a case, there may be an optical circulator located within each transceiver unit, in which case each optical circulator operates only on a single optical channel. In other embodiments, an optical circulator may be positioned next to the optical fiber portion 106 to separate signals propagating in different directions, in which case the optical circulator may be coupled to a first mux/demux that serves a number of transmitter units and a second mux/demux that serves a number of receiver units.

The spacing between adjacent wavelength signals, which may also be referred to as channels, is set by the particular WDM system being used. In some systems, the separation between wavelength channels may be 20 nm. In other words, a first channel may have a wavelength of 1310 nm and the next channel has a wavelength of the 1330 nm. In other systems, the separation between other channels may be less, for example 2 nm, 0.8 nm or less. In dense WDM (DWDM) systems, the channel separation may be as little as 100 GHz or even 50 GHz.

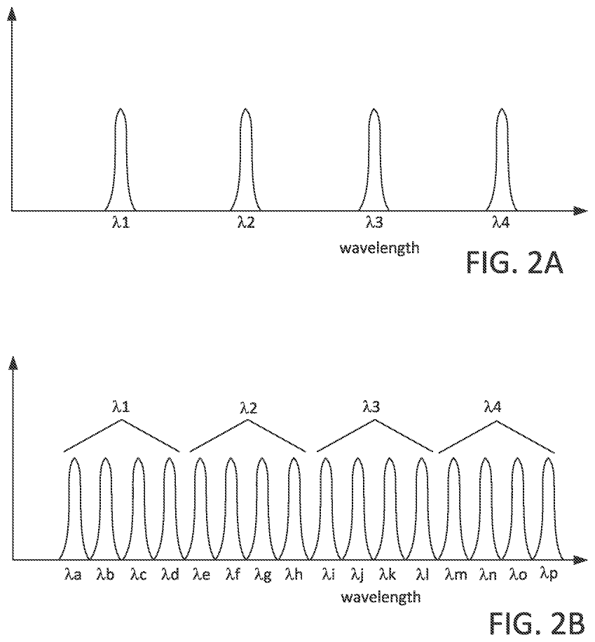

The terms “separated wavelength fiber” and “separated wavelength waveguide” as used herein refer to WDM signal components that have been separated from other components of the WDM signal. The terms may refer respectively to fibers and waveguides that carry a single wavelength component of the WDM signal that has been separated from the other WDM components. For example, if the common WDM signal contains four components at the wavelengths λ1, λ2, λ3, λ4, then each of the single wavelength fibers and waveguides may carry only one of those components, λ1, λ2, λ3, λ4, as is schematically illustrated in FIG. 2A. The term “separated wavelength” may also be used to describe fibers and waveguides that carry a selected group of adjacent WDM signal components that has been separated from the other WDM components. For example, as is illustrated in FIG. 2B, a WDM signal may comprise 16 separate wavelength components, λa, λb, . . . λn, λo, λp. The mux/demux device may separate these 16 components into groups, for example four groups with a first group called λ1 containing components at λa, λb, λc and λd, where λ1 is a representative wavelength of the first group. In this case, “λ1” may refer to one of the wavelength components in the group or may refer to some other wavelength indicative of the group, for example the center wavelength of the wavelength range that the group encompasses. There may be a second group called λ2, containing components at λe, λf, λg, λh, where λ2 is a representative wavelength of the second group, a third group called λ3 containing components λi, λj, λk, λl, where λ3 is a representative wavelength of the group, and a fourth group called λ4 containing components λm, λn, λo, λp, where λ4 is a representative wavelength of the group. The components within a group are all treated in the mux/demux unit in the same manner. For example, all the components in the λ1 group are directed to the same separated wavelength fiber, while the components in the λ2 group are directed a different separated wavelength fiber, and so on. It should be understood, therefore, that the term “separated wavelength,” when used to describe a component of a WDM signal, may refer to a single wavelength component or to a group of wavelength components that can be derived from, or combined into, a common WDM signal.

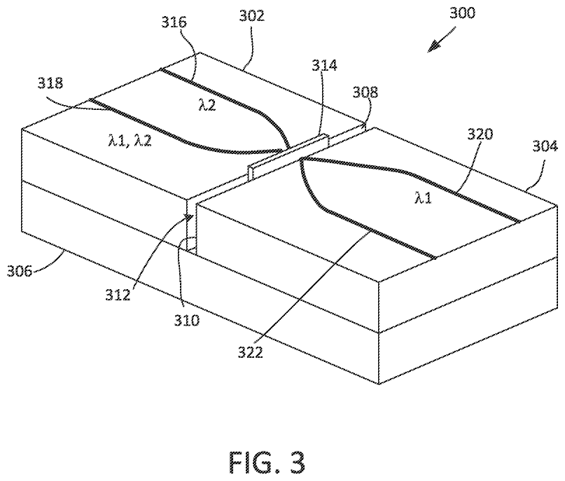

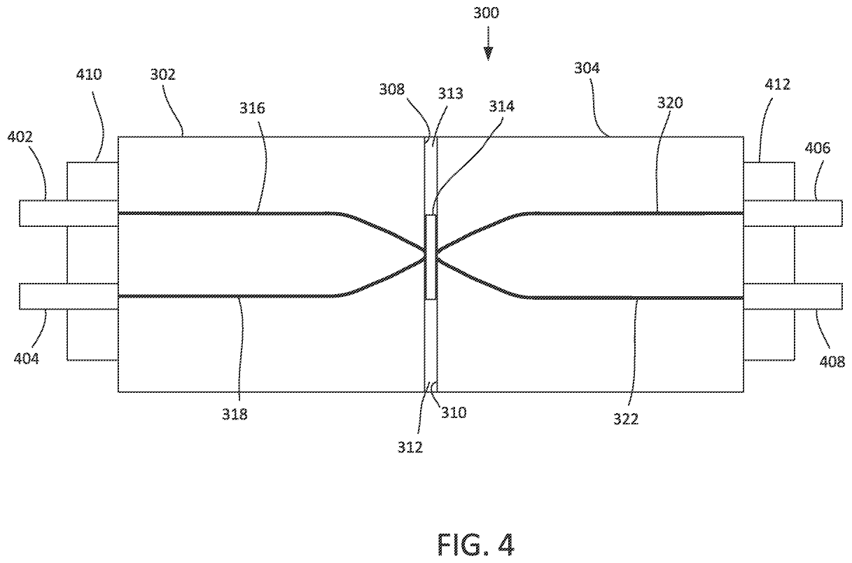

An exemplary embodiment of a two channel mux/demux unit 300 is schematically illustrated in perspective view in FIG. 3 and in plan view in FIG. 4. The mux/demux unit 300 includes a first upper substrate 302 and a second upper substrate 304. The first and second upper substrates 302, 304 may be mounted to a mounting element, or base substrate 306. A first side edge 308 of the first upper substrate 302 faces a second side edge 310 of the second upper substrate 304. A gap 312 between the first edge 308 and the second edge 310 accommodates a wavelength selective filter 314. The gap 312 may also contain an adhesive 313, for example a UV-curable optical epoxy, to adhere the first and second upper substrates 302, 304 together, and to fill the region of the gap between the upper substrates 302, 304 that does not contain the wavelength selective filter 314.

The first upper substrate 302 is provided with a first waveguide 316 and a second waveguide 318, which approach each other in the vicinity of the wavelength selective filter 314. In a similar fashion, the second upper substrate 304 is provided with a third waveguide 320 and a fourth waveguide, which approach each other in the vicinity of the wavelength selective filter 314.

Close to the gap 312, the first waveguide 316 and the fourth waveguide 322 are aligned so that light exiting the first waveguide 316 is directed towards the fourth waveguide 322 and vice-versa. Likewise, the second waveguide 318 and the third waveguide 320 are aligned so that light exiting the second waveguide 318 is directed towards the third waveguide 320, and vice versa. The wavelength selective filter 314 includes coating, such as a multilayer dielectric stack coating, or a Bragg coating or the like, that transmits light at a selected wavelength while reflecting light at other wavelengths. For example, if the wavelength selective filter 314 transmits light at wavelength λ1 and reflects light at λ2, then transmission of an optical signal at λ2 along the first waveguide 316 and another optical signal at λ1 along the third waveguide 320, results in a combined signal at λ1 and λ2 being transmitted along the second waveguide 318. Wavelength multiplexing/demultiplexing devices generally operate in reverse on signals propagating in the opposite direction. Thus, in this embodiment, a combined optical signal having components at λ1 and at λ2 propagating into the unit 300 along the second waveguide 318 will result in the component at λ1 being transmitted through the wavelength selective filter 314 to the third waveguide and the component at λ2 being reflected by the wavelength selective filter along the first waveguide 316. The wavelength selective filter 314 typically has a thickness of around 20 μm, although it may be slightly less than this. The upper substrates 302, 304 may be based on any type of material platform suitable for carrying the optical signals. One widely used platform in optical communications is the PLC platform, which is based on silica glass substrates. Waveguides may be produced within the glass substrate by doping, e.g. with germanium, or the like, or by transforming the material properties of the glass using, for example, femtosecond laser processing. Other material platforms that may be used include semiconductors, such as silicon, silicon nitride, indium phosphide and the like, or polymers such as Ormocore and Ormoclad polymers having respective first and second refractive indices, available from micro resist technology GmbH, Berlin, Germany.

The base substrate 306 may be formed of any suitable material for providing a solid mounting surface and stability. For example, the base substrate 306 may be a glass, such as a silica glass, or a semiconductor such as silicon.

The device 300 may be connected to external optical network elements via optical fibers 402, 404, 406, 408, as is schematically illustrated in FIG. 4. The fibers 402, 404, 406, 408 are aligned with respective waveguides 316, 318, 320, 322, and may be mounted relative to the device 300 via, for example, v-groove alignment blocks 410, 412, or any other suitable means, such as an MPO adaptor.

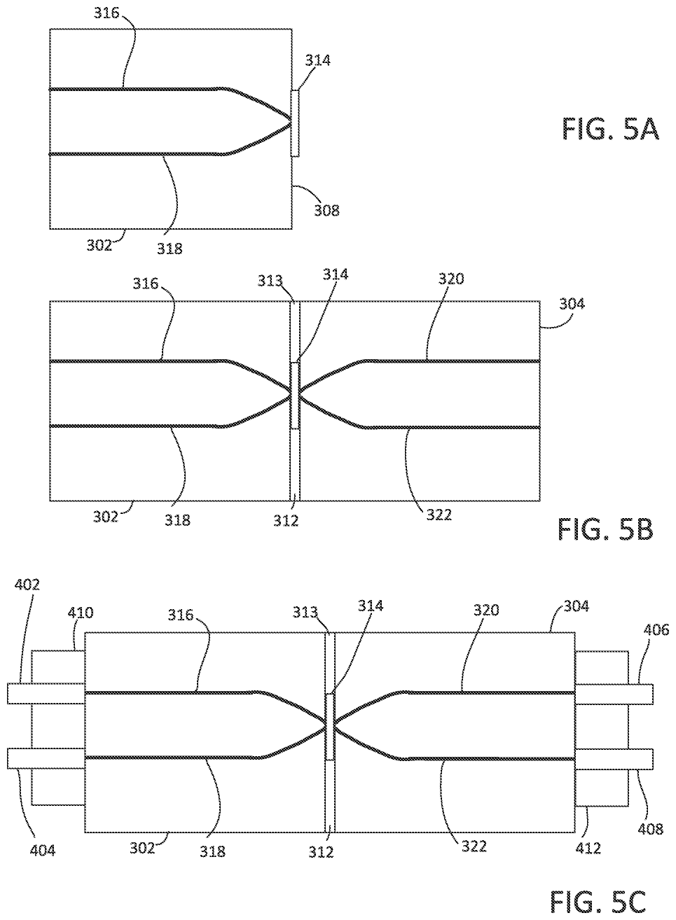

FIGS. 5A-5C schematically illustrate steps that may be taken for assembling the mux/demux unit 300. First, as shown in FIG. 5A, the wavelength selective filter 314 is attached to the first edge 308 of the first upper substrate 302, appropriately aligned with the first and second waveguides 316, 318, using an adhesive, for example a UV curable optical epoxy or the like. The first upper substrate 302 may have been mounted to the base substrate 306 (not shown) before the wavelength selective filter 314 is attached. Next, as is schematically illustrated in FIG. 5B, the second edge 310 of the second upper substrate 304 is attached to the other side of the wavelength selective filter 314 from the first upper substrate 302, with the first waveguide 316 aligned with the fourth waveguide 322 and the second waveguide 318 aligned with the third waveguide 320. There is a gap 312 between the first edge 308 of the first upper substrate 302 and the second edge 310 of the second upper substrate 304 due to the thickness of the wavelength selective filter 314. The gap 312 may be filled with an adhesive 313, which may be the same adhesive as is used to attach the wavelength selective filter 314 to the first upper substrate 302 or the second upper substrate 304, or another adhesive may be used. The refractive index of the adhesive used to adhere the wavelength selective filter 314 to the upper substrates 302, 304 may be selected to be similar to the refractive index of the waveguide cores at the edges 308, 310 to reduce reflective losses at the interfaces between the upper substrates 302, 304 and the adhesive. The edges 308, 310 of the upper substrates 302, 304 through which the optical signals propagate can be polished before assembly of the unit 300, which may lead to reduced optical losses. Furthermore, having open access to the edges 308, 310 prior to assembly of the unit 300 can lead to more even distribution of the adhesive between the wavelength selective filter 314 and the substrate edges 308, 310 compared to the distribution of the adhesive in an etched well or a sawn trench that receives the filter. Examples of suitable adhesives for securing a filter in a gap include, but are not limited to, an optical acrylate or epoxy, such as AT6001 specialty acrylate available from NTT Advanced Technology Corp. Tokyo Japan, and Optocast 3553 epoxy available from Electronic Materials Inc., Breckenridge, Colorado, U.S.A.

The external fibers 402, 404, 406, 408 may then be attached, as is schematically illustrated in FIG. 5C. For example, the fibers 402, 404 may be mounted in a v-groove alignment block 410, which is then attached to the first substrate 402 or to the mounting element 406 (not shown), with the fibers 402, 404 aligned with the first and second waveguides 416, 418 respectively. Also, fibers 406, 408 may be mounted in a v-groove alignment block 412, which is then attached to the second substrate 404 or to the mounting element 406 with the fibers 406, 408 aligned with the third and fourth waveguides 420, 422 respectively.

Signal losses incurred when passing from one waveguide to another via the wavelength selective filter may be reduced where the waveguides have expanded mode cores at the substrate edge. Expanding the waveguide core leads to the beam propagating with a larger beamwidth and a reduced divergence after leaving the confines of the waveguide. Thus, the beam does not diverge as much while propagating through the filter before entering the opposite waveguide, which means less of the optical signal is lost. Additionally, having a relatively large beam propagating in free space reduces the alignment tolerances in manufacturing the WDM unit.

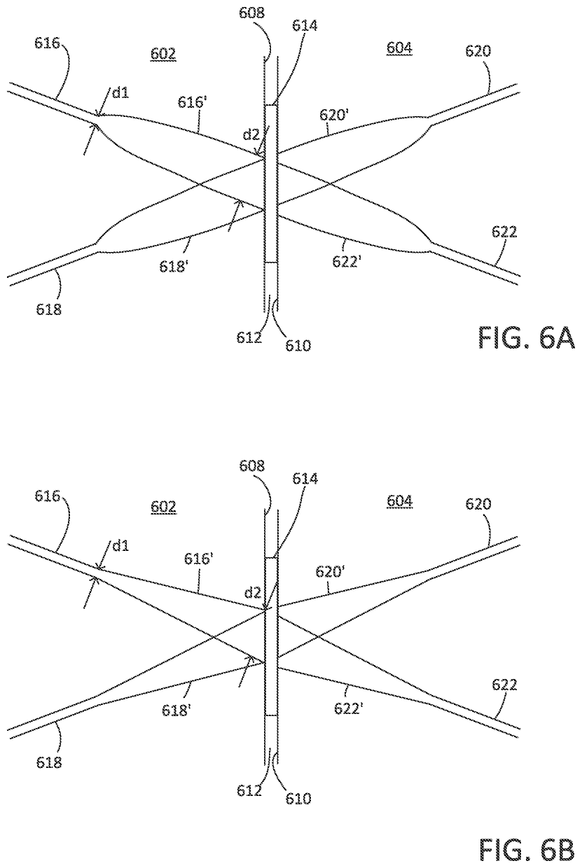

A first approach to expanding the waveguide cores is schematically illustrated in FIG. 6A. A first substrate side 602 and a second substrate side 604 are on opposite sides of a gap 612. The first substrate side 602 includes a first waveguide 616 and a second waveguide 618 and the second substrate side 604 includes a third waveguide 620 and a fourth waveguide 622. The first substrate side 602 has a first edge 608 facing a second edge 610 of the second substrate side 604. A wavelength selective filter 614 is disposed in the gap 612 between the first and second substrates 602, 604. The substrate sides 602, 604 may be parts of a single substrate lying on different sides of the gap 612 or, in other embodiments, the substrate sides 602, 604 may include upper substrates separated from each other buy the gap 612, both being mounted to a base substrate.

The first waveguide 616 is provided with a waveguide expansion region 616′, where the core area expands in a direction towards the wavelength selective filter 614. The width of the waveguide 616 at the beginning of the waveguide expansion region 616′ is d1, and is d2 at the end of the expansion region 616′. The waveguide may expand by any suitable amount. For example, in some embodiments, the value of d1 is around 8-9 μm and the value of d2 may be 15 μm or more, in some cases up to about 25-30 μm or more.

In the illustrated embodiment, the waveguide expansion region 616′ has a parabolic profile, which means that the width of the waveguide 616 increases in a parabolic manner as a function of position along the waveguide expansion region 616′ from the beginning, where the width is d1, to the end, where the width is d2. This profile has been shown to be efficient, having low losses, while maintaining a relatively short length to the waveguide expansion region 616′. The other waveguide expansion regions 618′, 620′, 622′ may have similar dimensions and use a similar expansion parabolic profile to those of the first waveguide expansion region 616′.

There is no requirement, however, that the profile of the waveguide expansion region is parabolic. The profile may take on other shapes, for example the profile may have a linear shape as schematically illustrated in FIG. 6B, in which the widths of the waveguides 616, 618, 620, 622 expand in a linear manner as a function of distance along the respective waveguide expansion regions 616′, 618′, 620′, 622′. The use of a mode expansion region for waveguides that feed a signal to an embedded wavelength selective filter is described further in WO 2013/188621.

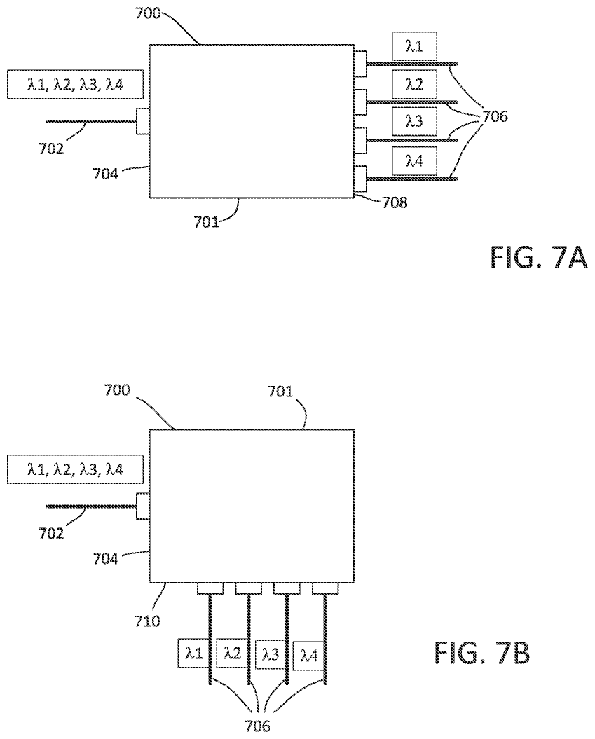

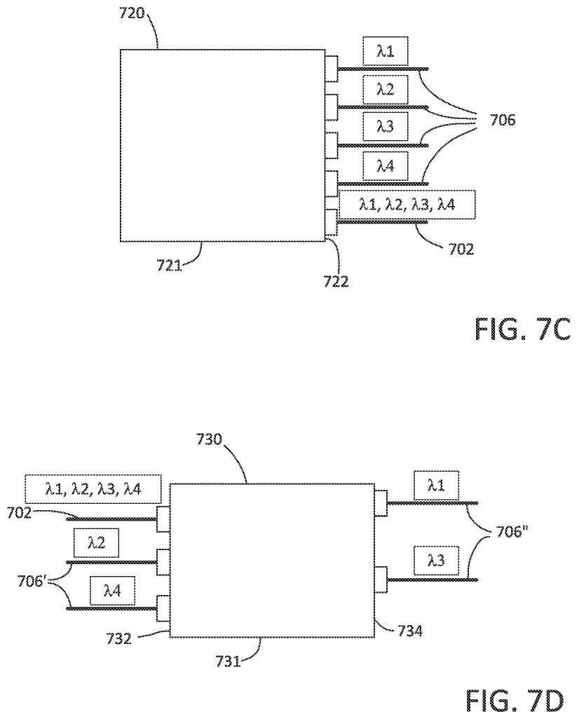

FIGS. 7A-7D schematically illustrate different physical configurations of WDM mux/demux devices, i.e. devices in which the relative positioning of the common input/output fiber and the separated wavelength fibers are different. In these illustrations, the WDM mux/demux device is a four channel device, having a common fiber carrying signal components at all four wavelengths, λ1, λ2, λ3, and λ4, and four separated wavelength fibers, each carrying a signal component at a single wavelength, i.e. at λ1, λ2, λ3, or λ4. It should be realized that a WDM mux/demux device may carry a different number of wavelength components, for example 2, 8, 12 16, or some other number. FIG. 7A schematically illustrates a first embodiment of an in-line mux/demux device 700 having a housing 701, in which the common fiber 702 is located on a first side 704 of the device 700 and the separated wavelength fibers 706 are located on a second side of the device 700. In the illustrated embodiment the separated wavelength fibers 706 are located on the side 708 of the device 700 opposite the first side 704 of the device 700. In another embodiment of in-line mux/demux device, the separated wavelength outputs 706 may be located on a side 710 that is lateral to the first side 704, as is schematically illustrated in FIG. 7B.

A butt-configuration mux/demux device 720 having a housing 721 is schematically illustrated in FIG. 7C, in which the common fiber 702 and the separated wavelength fibers 706 are all located on the same side 722 of the device 720. Lastly, a hybrid-configuration device 730 having a housing 731 is schematically illustrated in FIG. 7D, in which the common fiber 702 is located on the same side 732 as some of the separated wavelength fibers 706′, while other separated wavelength fibers 706″ are located on another side 734 of the device 730. It has been found that, in certain situations, e.g. as might arise in consideration of the space in which the WDM mux/demux device has to be located, it is difficult to implement butt-configuration and hybrid-configuration mux/demux devices because of the location of the common fiber on the same side as one or more of the separated wavelength fibers. An approach to overcoming this problem is to use an in-line configuration where the common fiber is not located at the same side of the device as any of the separated wavelength fibers.

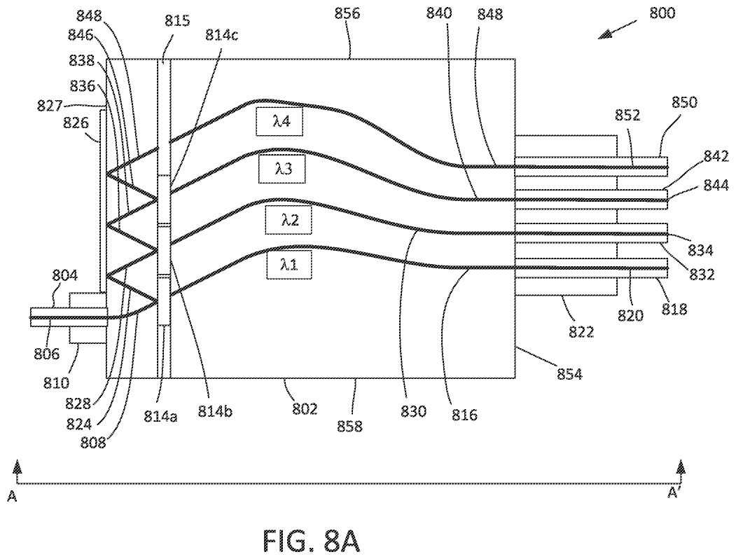

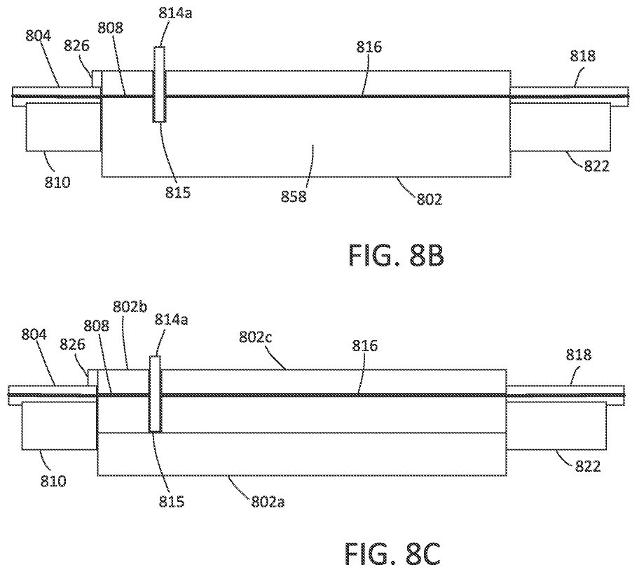

An exemplary embodiment of an integrated, in-line four channel WDM mux/demux unit 800, i.e. a mux/demux unit that handles optical signals having components of up to four different separated wavelengths, λ1, λ2, λ3, λ4, is schematically illustrated in FIG. 8A. The mux/demux unit 800 includes a first substrate 802. The first substrate 802 may be formed from an optically transparent material, for example a glass, such as silica, a semiconductor, such as silicon, or an optically transparent polymer. A common fiber 804 carries a combined WDM optical signal, having components of up to four different wavelengths, λ1, λ2, λ3, λ4. The common fiber 804 has a core 806 that is aligned to a common waveguide 808 on the substrate 802 so that the combined optical signal may couple between the core 806 and the common waveguide 808. The common fiber 804 and the common waveguide 808 carry all the wavelength components of the WDM signal entering or leaving the WDM mux/demux unit 800. The common fiber 804 may be aligned to the common waveguide 808 using any suitable method. For example, the common fiber 804 may be aligned using a first alignment block 810, such as a v-groove alignment block, although other shapes of groove may also be used. The substrate 802 may be described as having a common port where light from the common fiber 804 enters the common waveguide 808. Other methods of aligning the common fiber 804 to the common waveguide 808 may also be used.

The common waveguide 808 carries the combined optical signal from the common fiber 804 to a first wavelength selective filter 814a that is oriented parallel to the first edge 827 of the substrate 802. The first end of the common waveguide 808, close to the first edge 827 of the substrate, is perpendicular to the first edge 827. The common waveguide 808 is curved so that light incident at the first wavelength selective filter from the common waveguide has an angle of incidence greater than 0°. The wavelength selective filter 814a is located in a gap 815 in the substrate 802. The first wavelength selective filter 814a transmits light at one wavelength, or wavelength group, while reflecting light at other wavelengths, or wavelength groups. In this embodiment, the optical signal component at 21 is transmitted through the first wavelength selective filter 814a to a first separated wavelength waveguide 816 and is transported to the first separated wavelength fiber 818. The first separated wavelength fiber 818 may have a core 820 aligned to the first separated wavelength waveguide 816 via any suitable method, for example using a second alignment block 822. A separated wavelength fiber and a separated wavelength waveguide carry one of the wavelength components or wavelength groups of the WDM signal entering or leaving the WDM mux/demux unit 800. The substrate 802 may be described as having a first separated wavelength port where light exits the first separated wavelength waveguide 816 to the core 820 of the first separated wavelength fiber 818.

The remainder of the optical signal, with components at λ2, λ3, and λ4, is reflected by the first wavelength selective filter 814a along a first waveguide 824 to a reflector 826 which may be located at an edge 827 of the substrate 802. The reflector 826 may be any suitable reflecting element that effectively reflects light at the wavelengths λ2, λ3, λ4. For example, the reflector 826 may be a reflective coating applied to the substrate edge 827, such as a metallic coating, for example a gold coating, or may be a multilayer dielectric coating. In another approach, the reflector 826 may be a reflector on a substrate, such as a multilayer reflector or a metallic reflector, that is attached to the edge 827 of the substrate 802. The reflector 826 may be referred as a broadband reflector as it is capable of reflecting multiple wavelength components of the optical signal. In other embodiments, the reflector 826 may be located in a second gap in the substrate 802, between the substrate edge 827 and the gap 815 containing the first wavelength selective filter 814a.

The signal containing wavelengths λ2, λ3, λ4 is reflected by the reflector 426 along a second waveguide 828 to a second wavelength selective filter 814b. The second wavelength selective filter 814b transmits light at λ2 to a second separated wavelength waveguide 830 and on to a second separated wavelength fiber 832. The second separated wavelength fiber 832 may be aligned to the second separated wavelength waveguide 830 using any suitable method, for example via the alignment block 822. The substrate 802 may be described as having a second separated wavelength port where light exits the second separated wavelength waveguide 830 to the core 834 of the second separated wavelength fiber 832.

The remainder of the optical signal, with components at λ3 and λ4, is reflected by the second wavelength selective filter 814b along a third waveguide 836 to the reflector 826, where it is reflected along a fourth waveguide 838 towards a third wavelength selective filter 814c. The optical signal component at λ3 is transmitted through the third wavelength selective filter 814c to a third separated wavelength waveguide 840 and on to a third separated wavelength fiber 842. The third separated wavelength fiber 842 may be aligned to the third separated wavelength waveguide 840 via the alignment block 822. The substrate 802 may be described as having a third separated wavelength port where light exits the third separated wavelength waveguide 840 to the core 844 of the third separated wavelength fiber 842.

The remainder of the optical signal, containing only the component at λ4, is reflected by the third wavelength selective filter 814c along a fifth waveguide 846 to the reflector 826, where it is reflected along a fourth separated wavelength waveguide 848 to a fourth separated wavelength fiber 850. The fourth separated wavelength fiber 850 may be aligned to the fourth separated wavelength waveguide 848 via the alignment block 822. The substrate 802 may be described as having a fourth separated wavelength port where light exits the fourth separated wavelength waveguide 848 to the core 852 of the fourth separated wavelength fiber 850.

In this embodiment the wavelength selective filters 814a-c are described as transmitting different wavelength components, λ1, λ2, and λ3 respectively. It should be noted that the angle of incidence of the optical signal on each of the wavelength selective filters 814a-c is the same,

In some embodiments, the fourth separated wavelength waveguide 848 crosses the gap 815, as illustrated. In other embodiments, the gap 815 may not extend sufficiently beyond the third wavelength selective filter 814c as to intersect the fourth separated wavelength waveguide 848, in which case the fourth separated wavelength waveguide 848 may extend uninterrupted between the reflector 826 and the fourth separated wavelength port.

In this embodiment, the common fiber 804 is aligned to the common waveguide 808 by a first alignment block 810 at one edge 827 of the substrate 802 and the individual separated wavelength fibers 818, 832, 842, 850 are aligned to their respective waveguides 816, 830, 840, 848 by a single alignment block 822 at an opposite edge 454 of the substrate. In such a case, all the separated wavelength fibers 818, 832, 842, 850 may be coupled to the WDM mux/demux unit 800 by a single fiber connector.

The alignment blocks 810, 822 may be attached separately to the substrate 802 or may be formed integrally with the substrate 802. Approaches for forming integrated alignment blocks with an optical substrate are discussed, for example, in U.S. Patent Publication No. 2018/0217333, incorporated herein by reference. One approach for forming an integrated alignment block is to use femtosecond 3D processing to make the treated glass more susceptible to an etchant than untreated glass. Thus, if the device mux/demux unit 800 is formed using femtosecond laser processing for etching and femtosecond laser 3-D writing of the waveguides, then the entire device, including integrated with the alignment blocks 810, 822 may be formed in a single femtosecond laser processing operation.

The common fiber 804 and the separated wavelength fibers 18, 832, 842, 850 may be fiber pigtails that pass outside the housing (not shown) of the device 800 to connect to additional respective separated wavelength fibers. In other embodiments, the common fiber 804 and the separated wavelength fibers 818, 832, 842, 850 may each terminate at a fiber connector on the housing wall (not shown) of the device 800.

The gap 815 typically has a width in the range 15-50 μm to receive the wavelength selective filters 814a-c, and may have a depth in the range 100-300 μm so as to provide sufficient depth that the filter totally intersects the incident waveguides and provides sufficient mechanical support to hold the filter perpendicular relative to the waveguides. The wavelength selective filters 814a-c may be maintained in position within the gap 815 using an optical adhesive. For example, adhesive may be placed within the empty gap 815, and then the filter is inserted into the adhesive within the gap. It is advantageous that the adhesive coat both sides of the filter within the gap 815 so as to provide index matching between the filter and the waveguides.

The gap 815 may be formed in the substrate 802 using any suitable method, including those described above. In one approach, the gap 815 may be formed by cutting a groove across the substrate 802 using, for example, a diamond dicing saw. In such a case the gap 815 may extend all the way to the lateral edges 856, 858 of the substrate 802, although this is not a requirement. The gap 815 extending to the lateral edge 858 can be seen in the side view of the device 800 schematically illustrated in FIG. 8B, which shows the side view looking in the direction AA′ in FIG. 8A. In another approach the gap 815 may be formed using an etching process, for example deep reactive ion etching (DRIE) or femtosecond enhanced etching. The etched gap 815 may extend to the lateral edges 856, 858 of the substrate 802, although it need not extend to one or both of the edges 856, 858.

In another approach the substrate 802 may be formed using a three piece structure, which uses a base substrate 802a, a first upper substrate 802b and a second upper substrate 802c, as is schematically illustrated in the side view shown in FIG. 8C, in a manner like that discussed above with reference to FIGS. 3-5. The first upper substrate 802b is connected to the common fiber 804 and includes the common waveguide 808 and the first, second, third, fourth and fifth waveguides 824, 828, 836, 838, 846 and part of the fourth separated waveguide 848. The second upper substrate 802c includes the first, second, third, and fourth separated wavelength waveguides 816, 830, 840, 848 and is connected to the first, second, third, and fourth separated wavelength fibers 818, 832, 842, 850. The substrates 802a-c and filters 814a-c may be held together using any suitable optical adhesive, for example one of the optical adhesives described above.

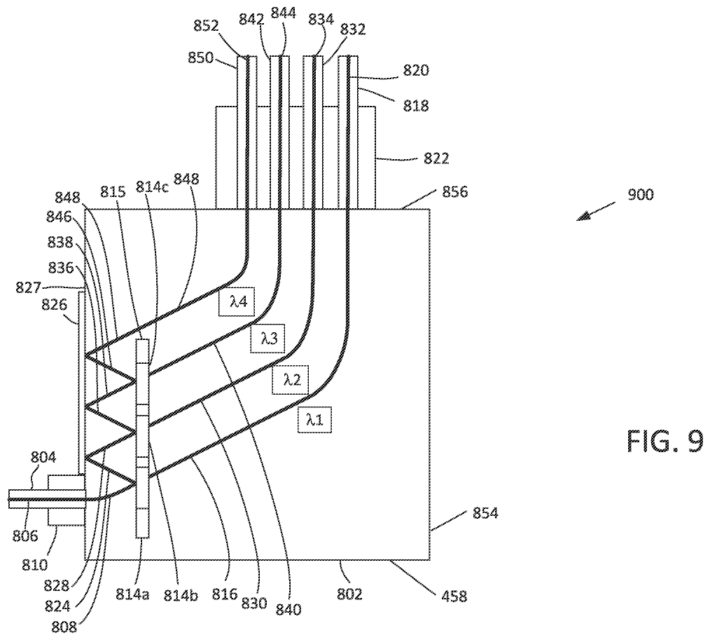

FIG. 9 schematically illustrates another embodiment of an integrated, four channel WDM mux/demux device 900. The elements of this in-line device 900 are similar to those of the device 800, and are indicated with the same element numbers as in FIG. 8A. The device 900 is an in-line device because the common input/output is at one edge 827 of the substrate 802, while the separated wavelength inputs/outputs are all on a different edge of the substrate 802, in this case the lateral edge 856. In this illustrated embodiment, the gap 815 that contains the wavelength selective filters 814a-c does not extend all the way to the lateral edges 856, 858 of the substrate 802 and the fourth separated wavelength waveguide 848 bypasses the gap 815. Furthermore, the separated wavelength waveguides 816, 830, 840, 848 terminate at the lateral edge 856.

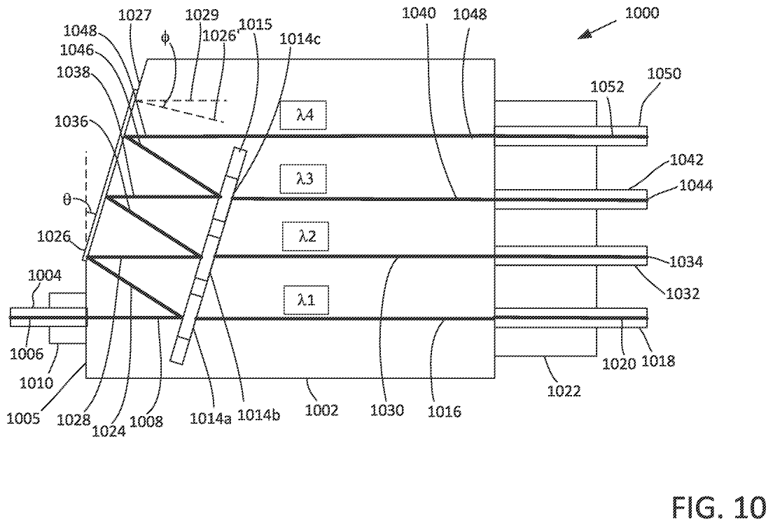

Another embodiment of in-line, integrated four channel WDM mux/demux device 1000 is schematically illustrated in FIG. 10. In this embodiment, the wavelength selective filters and broadband reflector are set at a non-perpendicular angle to the common waveguide 1008, which permits the device to be manufactured with straight waveguides.

The mux/demux unit 1000 includes a substrate 1002. The substrate 1002 may be formed from a glass, such as silica, may be formed from a semiconductor such as silicon, or from a polymer. A common fiber 1004 carries a combined optical signal, having components at four different wavelengths, λ1, λ2, λ3, λ4. The common fiber 1004 has a core 1006 that is aligned to a common waveguide 1008 on the substrate 1002 so that the combined optical signal may couple between the core 1006 and the common waveguide 1008. The common fiber 1004 and the common waveguide 1008 carry all the wavelength components of the WDM signal entering or leaving the WDM mux/demux unit 1000. The common fiber 1004 may be aligned to the common waveguide 1008 using any suitable method. For example, the common fiber 1004 may be aligned using a first alignment block 1010, such as a v-groove alignment block. The substrate 1002 may be described as having a common port where light from the common fiber 1004 enters the common waveguide 1008.

The common waveguide 1008 carries the combined optical signal from the common fiber 1004 to a first wavelength selective filter 1014a. The first wavelength selective filter 1014a transmits light at one wavelength, or wavelength group, while reflecting light at other wavelengths, or wavelength groups. In this embodiment, the optical signal component at λ1 is transmitted through the first wavelength selective filter 1014a to a first separated wavelength waveguide 1016 and is transported to the first separated wavelength fiber 1018. The first separated wavelength fiber 1018 may have a core 1020 aligned to the first separated wavelength waveguide 1016 using a second alignment block 1022. The substrate 1002 may be described as having a first separated wavelength port where light exits the first separated wavelength waveguide 1016 to the core 1020 of the first separated wavelength fiber 1018. The wavelength selective filter 1014a is located in a gap 1015 in the substrate 1002.

The remainder of the optical signal, with components at λ2, λ3, and λ4, is reflected by the wavelength selective filter 1014a along a first waveguide 124 to a reflector 1026 located at an angled edge 1027 of the substrate 1002. As has been described above, the reflector 1026 may be a broadband reflector attached to the angled edge 1027 or it may be deposited on the angled edge 1027. The angled edge 1027 and the input edge 1005 of the substrate 1002, where the common fiber 1004 mates with the common waveguide 1008, lie at a first end of the substrate 1002. The angled edge 1027 is at an angle, θ, relative to the input end 1005, where 0°<θ<90°. In some embodiments θ≤60° and in others θ≤45°. In some embodiments, θ≥5°, θ≥10° in others and θ≥20° in other embodiments. Also, a normal 1026′ to the reflector 1026 forms an angle φ relative to line 1029 which is parallel to an axis of the common optical path 1008. Since φ is greater than zero, the normal 1026′ to the reflector 1026 is not parallel to the common waveguide 1008. The angle φ is also the angle of incidence at the reflector 1026. Where the common optical waveguide 1008 is perpendicular to the input edge 1005, θ=φ.

The signal containing wavelengths λ2, λ3, λ4 is reflected by the reflector 1026 along a second waveguide 1028 to a second wavelength selective filter 1014b. The second wavelength selective filter 1014b transmits light at λ2 to a second separated wavelength waveguide 1030 and on to a second separated wavelength fiber 1032. The second separated wavelength fiber 1032 may be aligned to the second separated wavelength waveguide 1030 via the alignment block 1022. The substrate 1002 may be described as having a second separated wavelength port where light exits the second separated wavelength waveguide 1030 to the core 1034 of the second separated wavelength fiber 1032.

The remainder of the optical signal, with components at λ3 and λ4, is reflected by the second wavelength selective filter 1014b along a third waveguide 1036 to the reflector 1026, where it is reflected along a fourth waveguide 1038 towards a third wavelength selective filter 1014c. The optical signal component at λ3 is transmitted through the third wavelength selective filter 1014c to a third separated wavelength waveguide 1040 and is transported to a third separated wavelength fiber 1042. The third separated wavelength fiber 1042 may be aligned to the third separated wavelength waveguide 1040 via the alignment block 1022. The substrate 1002 may be described as having a third separated wavelength port where light exits the third separated wavelength waveguide 1040 to the core 1044 of the third separated wavelength fiber 1042.

The remainder of the optical signal, containing only the component at λ4, is reflected by the third wavelength selective filter 1014c along a fifth waveguide 1046 to the reflector 1026, where it is reflected along a fourth separated wavelength waveguide 1048 to a fourth separated wavelength fiber 1050. The fourth separated wavelength fiber 1050 may be aligned to the fourth separated wavelength waveguide 1048 via the alignment block 1022. The substrate 1002 may be described as having a fourth separated wavelength port where light exits the fourth separated wavelength waveguide 1048 to the core 1052 of the fourth separated wavelength fiber 1050.

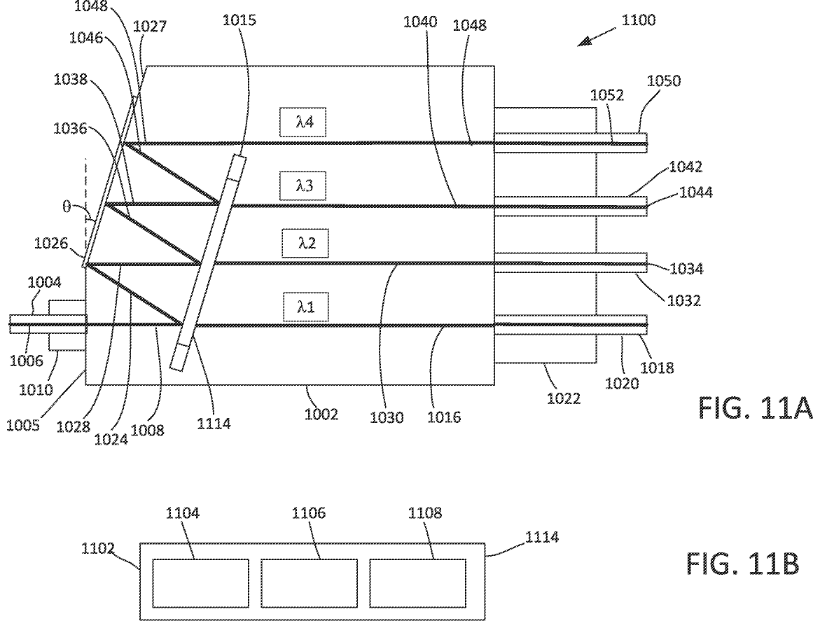

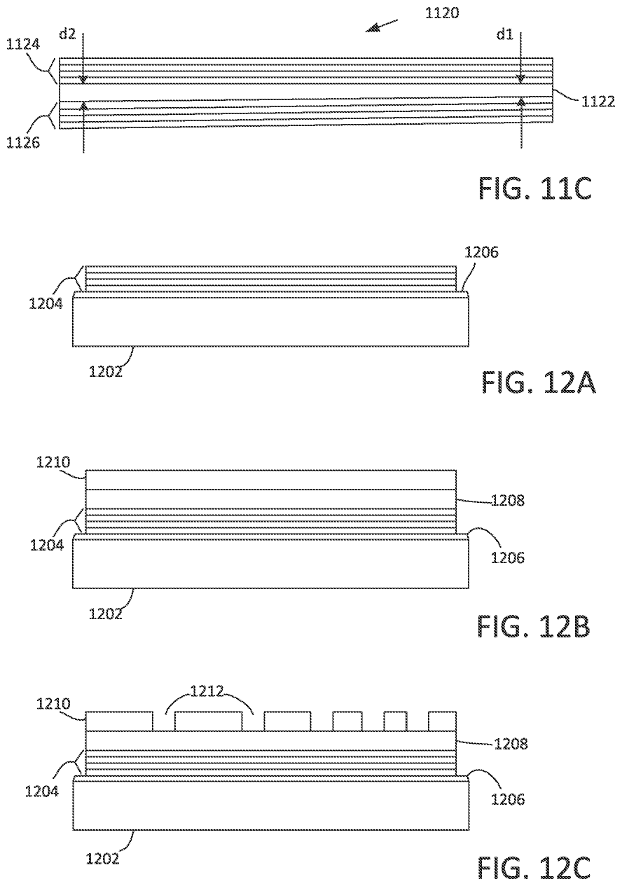

Another embodiment of integrated, in-line WDM mux/demux device 1100 is schematically illustrated in FIG. 11A. This device 1100 is similar to that shown in FIG. 10, with like elements designated by like element numbers. In this device, the gap 1015 contains a wavelength selective filter unit 1114 that has a transmission wavelength that is dependent on the location that light is incident on it. For example, the region of the wavelength selective filter unit 1114 between the common waveguide 1008 and the first separated wavelength waveguide 1016 is transmissive at λ1 and reflective at λ2, λ3 and λ4, the region of the wavelength selective filter unit 1114 between the second waveguide 728 and the second separated wavelength waveguide 1030 is transmissive at λ2 and reflective at) λ3 and λ4, and the region of the wavelength selective filter unit 1114 between the fourth waveguide 1038 and the third separated wavelength waveguide 1040 is transmissive at λ3 and reflective at λ4.

One embodiment of wavelength selective filter unit 1114, which may be referred to as a filter cassette, is schematically illustrated in FIG. 11B. A transparent filter unit substrate 1102 supports three wavelength selective filters 1104, 1106, 1108. Each wavelength selective filter 1104, 1106, 1108 is transmissive at one wavelength while being reflective at the others. For example, filter 1104 may be transmissive at λ1 while being reflective at λ2, λ3, and λ4, filter 1106 may be transmissive at λ2 while being reflective at λ3 and λ4, and filter 1108 may be reflective at λ3 while being reflective λ4. The filter unit substrate 1102 may have a thickness in the range 10-30 μm, although it may also have a thickness outside this range. The wavelength selective filters 1104, 1106, 1108 may be attached to the filter unit substrate 1102 using an optical adhesive.

In another embodiment, the wavelength selective filter unit 1114 may be a linear variable filter (LVF) which, due to one or more layers having a thickness that is tapered along the length of the filter, has a transmission wavelength that varies continuously along the length of the LVF. FIG. 11C schematically illustrates a cross-sectional view through one embodiment of an LVF 1120. The LVF 1120 includes a spacer layer 1122, a first reflective stack 1124 on one side of the spacer layer 1122 and a second reflective stack 1126 on the other side of the spacer layer 1122. In this embodiment, the spacer layer 1122 is tapered, having a smaller thickness, d1, at the right end and a larger thickness, d2, at the left end, so that d2>d1. The reflective stacks 1124, 1126 may each include a number of layers of alternating relatively low and high refractive index material to provide a reflective stack that is reflective over the wavelength range of interest. The reflective stacks 1124, 1126 may, for example, be formed as stacks of vacuum deposited dielectric material, for example using TiO₂ as the high index material and SiO₂ as the low index material. The reflective stacks may also be formed of stacks of different materials, such as polymeric materials.

In the present description, where a WDM mux/demux unit is described as having a first and a second wavelength selective filter, it should be understood that these may eb separate filters, or different portions of a wavelength selective filter unit such as a filter cassette or LVF that transmit light at respective first and second wavelengths.

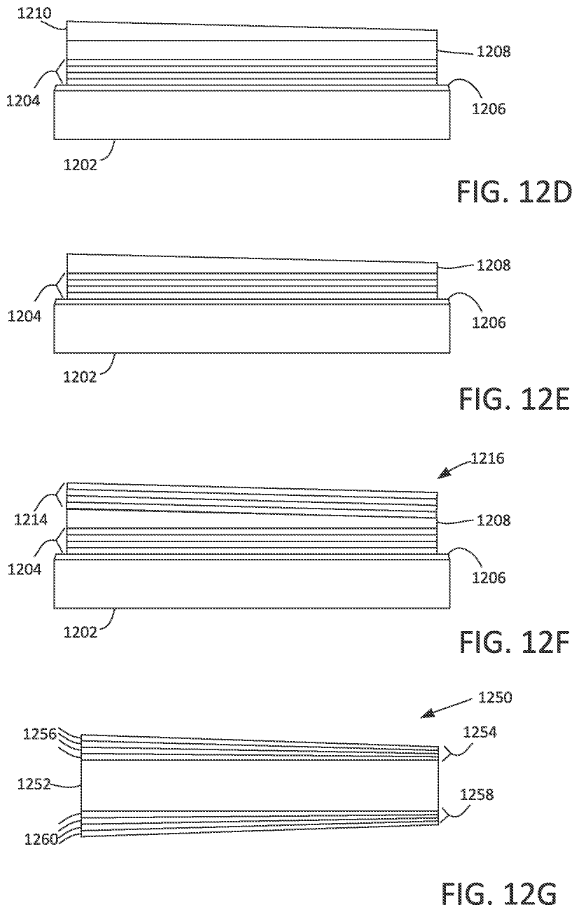

One approach to forming an LVF having a tapered spacer layer is now described with reference to FIGS. 12A-12F. A first reflective multilayer stack 1204, that is reflective over the wavelength range of interest, is deposited on a substrate 1202, as is schematically illustrated in FIG. 12A. The substrate 1202 may be, for example, a glass substrate or a semiconductor substrate made from, for example, silicon. The first reflective stack 1204 may be deposited on a lift-off layer 1206 that is on the upper surface of the substrate 1202. The lift-off layer 1206 allows for detachment of the finished LVF from the substrate 1202 and may include, for example, an etchable material such as a resist. A spacer layer 1208 is then deposited over the first reflective stack 1204, and then a layer of photoresist 1210 deposited over the spacer layer 1208, as is schematically illustrated in FIG. 12B. The spacer layer 1208 is formed of a material that is transparent at the wavelength range of interest and may be an oxide layer, for example a layer of SiO₂, and may be deposited using any suitable method. For example, an oxide spacer layer 1208 may be deposited using a vacuum deposition process such as chemical vapor deposition, sputtering, or the like. The photoresist layer 1210 may be applied using any suitable method, such as spin-coating.

The photoresist layer 1210 is then patterned to define a strip-like structure, as is schematically illustrated in FIG. 12C. The patterning may include a series of trenches 1212 of constant width with variable spatial frequency, or trenches of variable width and constant pitch, or a combination of the two, to vary the effective amount of resist per unit area across the substrate. The photoresist layer 1210 is then reheated to permit reflow to take place, resulting in the patterning being converted to a smoothly tapered photoresist layer 1210, as is schematically illustrated in FIG. 12D. In another approach, a tapered photoresist layer may be achieved using Grey Scale Lithography. The tapered photoresist layer 1210 may then be subject to an appropriate plasma etch, in which the topography of the tapered photoresist layer 1210 is transferred to the spacer layer 1208, resulting the spacer layer 1208 being tapered, as is schematically illustrated in FIG. 12E. A second reflective stack 1214 may then be deposited on the tapered spacer layer 1208 to complete the LVF 1216. The LVF 1216 may subsequently be removed from the substrate 1202 by etching the lift-off layer 1206.

As will be understood, the LVF 1216 having a linearly tapered spacer layer 1208 operates in a manner similar to a Fabry-Perot filter. Since the thickness of the spacer layer 1208 varies linearly across the LVF, so does the wavelength of light that is transmitted through the LVF. This type of LVF, and its fabrication, are explained in greater detail in Emadi A et al., “Design and implementation of a sub-nm resolution microspectrometer based on a Linear-Variable Optical Filter,” Opt. Express (2012) vol. 20, 489-507, which is incorporated herein by reference.

Another approach to making an LVF is for the thicknesses of the layers of the reflective coating be tapered, as is discussed in greater detail in Tang H et al., “Preparation and Spectrum Characterization of a High Quality Linear Variable Filter,” Coatings (2018) vol. 8, 308 (“Tang”), incorporated herein by reference. A substrate is provided on one side with a narrow bandpass filter coating, the other with a wide cut-off filter coating, which may be formed as a multilayer dielectric stack. In this approach the coatings are deposited on the substrate with a thickness that varies linearly across the substrate. In other words, the layers of the dielectric stack have a tapered profile. An exemplary embodiment of such an LVF 1250 is schematically illustrated in FIG. 12G. The LVF 1250 is formed around a substrate 1252, with a first stack 1254 of tapered layers 1256, and a second stack 1258 of tapered layers 1260.

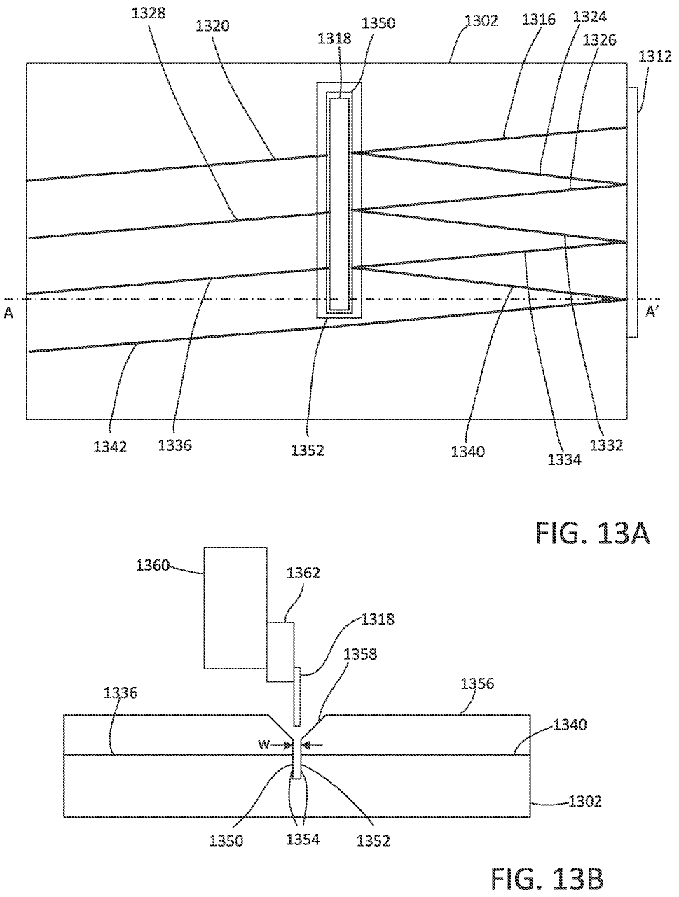

One approach to mounting wavelength selective filters in a substrate is schematically illustrated in FIGS. 13A and 13B, which show a section of the substrate 1302 that includes a wavelength selective filter unit 1318 and a reflector 1312, along with various waveguides within the substrate 1302.

FIG. 13A schematically illustrates the filter unit 1318 inserted into gap in the substrate 1302 in the form of a well 1350, while FIG. 13B schematically illustrates a procedure to insert the filter unit 1318 into the well 1350. For the purposes of the present disclosure, the term “filter unit” may be used to describe any arrangement of one or more wavelength selective filters inserted into a gap in the substrate including, but not limited to, a number of individual wavelength selective filters having respective transmission wavelengths, a wavelength selective filter cassette, or an LVF. Filter units may be used in any of the embodiments of WDM mux/demux described herein. Furthermore, a “first wavelength selective filter transmissive at a first wavelength” refers to any type of wavelength selective filter that may be present in the gap, such as an individual filter, a portion of a filter cassette, or a portion of an LVF, that transmits light at the first wavelength.

FIG. 13B schematically illustrates the cross-section AA′ indicated in FIG. 13A. In the lower part 1352 of the well 1350, the sidewalls 1354 are parallel to each other and perpendicular to the upper surface 1356 of the substrate 1302. The sidewalls 1354 may be separated by a distance, w, of 15 μm or more, in some cases up to about 25-30 μm or more, depending on the thickness of the filter unit 1318 and the margin between the filter unit 1318 and the sidewall 1354. The lower part 1352 of the well 1350 is at the same depth as the waveguides so that the waveguides 1316, 1320, 1324, 1326, 1328, 1332, 1334, 1336, and 1340 terminate at the vertical sidewalls 1354. In the upper part 1358 of the well 1350, the sidewalls may form a tapered profile, which aids in the placement of the filter unit 1318 into the well 1350.

Exemplary apparatus for placing the filter unit 1318 in the well 1350 is schematically illustrated above the substrate in FIG. 13B. A gripper or chuck 1360, for example a vacuum chuck, holds a glass support 1362. The filter unit 1318 may be held on the glass support 1362 via a gel film. Using a 3-D precision translation stage, the chuck 1360 is moved so that the filter unit 1318 is directly above the well 1350. The chuck 1360 is then moved closer to the substrate 1302 so that the filter unit 1318 slips into the well 1350. Some adhesive may be provided on the faces of the filter unit 1318 prior to insertion in the well 1350 so that, once inserted into the well 1350, the filter unit is adhered to the sidewalls 1354. The adhesive may also act as an index matching medium between the material of the chip substrate and the material of the filter unit 1318, so as to reduce reflective losses. Once the filter unit 1318 is located in the well 1350, the filter unit 1318 may be mechanically removed from the glass support 1362. For example, the chuck 1360 may move in a direction into the plane of the illustration, resulting in the filter unit 1318 sliding off the glass support 1362.

A top view of the filter unit 1318 in the well 1350 is schematically shown in FIG. 13A. The well 1350 may be prepared to be slightly oversized relative to the filter unit 1318, to permit the filter unit 1318 to enter the well 1350 and to allow for adhesive between the filter unit 1318 and the sidewalls 1354.

The well 1350 may be prepared using any suitable technique, such as deep reactive ion etching (DRIE). Another approach that may be used is femtosecond laser-assisted chemical etching of fused silica glass. A volume of glass that has been exposed to femtosecond laser radiation has a higher etch rate than unexposed glass and can be selectively removed in a subsequent wet etching step. A multi-pass scanning technique is used to expose the volume of substrate material that is to be etched to form the well using a femtosecond laser. The volume of material to be removed is exposed to the focused femtosecond laser beam by scanning the unprocessed chip past the focus of a femtosecond laser. One suitable laser system for this is an ytterbium-doped fiber laser (Satsuma model, available from Amplitude Systèmes, Pessac, France) frequency doubled to produce a wavelength of 515 nm. The pulse length is <400 fs at a repetition rate of 500 kHz. The laser beam is linearly polarized and may be focused using a low MA lens, such as a 0.6 NA aspheric lens (Newport 5722-A-H). The substrate chip being processed may be mounted on a motorized stage that can be translated at speeds, for example, in the range of 1-10 mm/s. Average processing laser power may be in the range of 50-250 mW and average vertical step size in the range of 1-2 μm.

Following exposure of the substrate material to femtosecond laser radiation, the substrate surface is exposed to an aqueous solution of potassium hydroxide (KOH) or hydrofluoric acid (HF). The use of KOH rather than HF has been found to produce a significantly improved selectivity between the exposed and unexposed regions, which allows for fabrication of high-aspect-ratio features, such as a well 1350 with controllable and uniform width.

One advantage of placing the LVF in a well, compared with the prior art method of picking and placing individual bulk components and attaching them to a substrate, is that the alignment of the reflecting and transmitting elements in the mux/demux device is achieved via the lithographic methods used to write the waveguides and create the filter wells, rather than relying on the accuracy of the pick-and-place machine used on assembling bulk components. Furthermore, the use of an LVF reduces the number of components that have to be assembled in the manufacture of the mux/demux unit.

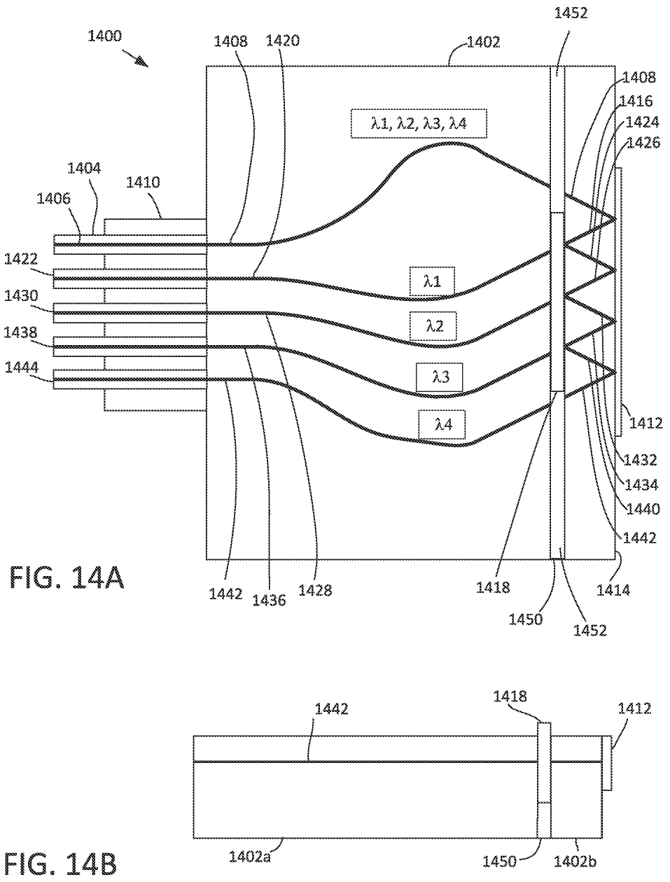

Another embodiment of a four-channel WDM mux/demux unit 1400 in a butt-configuration is schematically illustrated with reference to FIGS. 14A and 14B. The unit 1400 includes a first substrate 1402, which may include two upper substrates 1402a, 1402b separated by a gap 1450 that contains a filter unit 1418. The upper substrates 1402a, 1402b may be supported on a base substrate (not shown). A common fiber 1404 carries a combined optical signal, having components at four different wavelengths, λ1, λ2, λ3, λ4. The common fiber 1404 has a core 1406 that is aligned to a common waveguide 1408 on the substrate 1402 so that the combined optical signal may couple between the core 1406 and the common waveguide 1408. The common fiber 1404 and the common waveguide 1408 carry all the wavelength components of the WDM signal entering or leaving the WDM mux/demux unit 1400. The common fiber 1404 may be aligned to the common waveguide 1408 using any suitable method, such as an alignment block 1410. The substrate 1402 may be described as having a common port where light from the common fiber 1404 enters the common waveguide 1408.

The first common waveguide 1408 carries the combined optical signal to a reflector 1412, which may be located on an edge 1414 of the substrate 1402 that is opposite to the alignment block 1410. The reflector 1412 reflects the combined optical signal into a second common waveguide 1416 which transports the combined optical signal from the reflector 1412 to a linear variable filter 1418. The reflector 1412 may be any suitable reflecting element that effectively reflects light at the wavelengths λ1, λ2, λ3, λ4.

A filter unit 1418, which may be an arrangement of individual wavelength selective filters having respective transmission wavelengths, filter cassette or an LVF, transmits light at one wavelength while reflecting light at other wavelengths. The combined optical signal propagating along the second common waveguide 1416 is incident at the filter unit 1418 at a point where the filter unit 1418 transmits light at λ1. Accordingly, the optical signal component at λ1 is transmitted through the filter unit 1418 to a first separated wavelength waveguide 1420 and is transported to the first separated wavelength fiber 1422. The first separated wavelength fiber 1422 may have a core aligned to the first separated wavelength waveguide 1420 via the alignment block 1410. The substrate 1402 may be described as having a first separated wavelength port where light exits the first separated wavelength waveguide 1420 to the core of the first separated wavelength fiber 1422. The filter unit 1418 is located in a gap 1452 in the substrate 1402.

The remainder of the optical signal, with components at λ2, λ3, and λ4, is reflected by the filter unit 1418 along a first waveguide 1424 to the reflector 1412, where it is reflected along a second waveguide 1426 back to the filter unit 1418. The optical signal propagating along the second waveguide 1426 is incident at the filter unit 1418 at a point where the filter unit 1418 transmits light at λ2. Accordingly, the optical signal component at λ2 is transmitted through the filter unit 1418 to a second separated wavelength waveguide 1428 and is transported to the second separated wavelength fiber 1430. The second separated wavelength fiber 1430 may be aligned to the second separated wavelength waveguide 1428 via the alignment block 1410. The substrate 1402 may be described as having a second separated wavelength port where light exits the second separated wavelength waveguide 1428 to the core of the second separated wavelength fiber 1430.

The remainder of the optical signal, with components at λ3 and λ4, is reflected by the filter unit 1418 along a third waveguide 1432 to the reflector 1412, where it is reflected along a fourth waveguide 1434 back to the filter unit 1418. The optical signal propagating along the fourth waveguide 1434 is incident at the filter unit 1418 at a point where the filter unit 1418 transmits light at λ3. Accordingly, the optical signal component at λ3 is transmitted through the filter unit 1418 to a third separated wavelength waveguide 1436 and is transported to the third separated wavelength fiber 1438. The third separated wavelength fiber 1438 may be aligned to the third separated wavelength waveguide 1436 via the alignment block 1410. The substrate 1402 may be described as having a third separated wavelength port where light exits the third separated wavelength waveguide 1436 to the core of the third separated wavelength fiber 1438.

The remainder of the optical signal, containing only the component at λ4, is reflected by the filter unit 1418 along a fourth separated wavelength waveguide 1440 to the reflector 1412, where it is reflected along a fifth separated wavelength waveguide 1442 to a fourth separated wavelength fiber 1444. The fourth separated wavelength fiber 1444 may be aligned to the fifth separated wavelength waveguide 1442 via the alignment block 1410. The substrate 1402 may be described as having a fourth separated wavelength port where light exits the fifth separated wavelength waveguide 1442 to the core of the fourth separated wavelength fiber 1444.

In this embodiment, the common fiber 1404 and the individual separated wavelength fibers 1422, 1430, 1438, 1444 are aligned to their respective waveguides 1408, 1420, 1428, 1436, 1442 by a single alignment block 1410 in which case all the fibers 1404, 1422, 1430, 1438, 1444 may be coupled to the WDM mux/demux unit 1400 by a single fiber connector. In other embodiments, the common signal may be connected to the unit 1400 separately from the separated wavelength components.

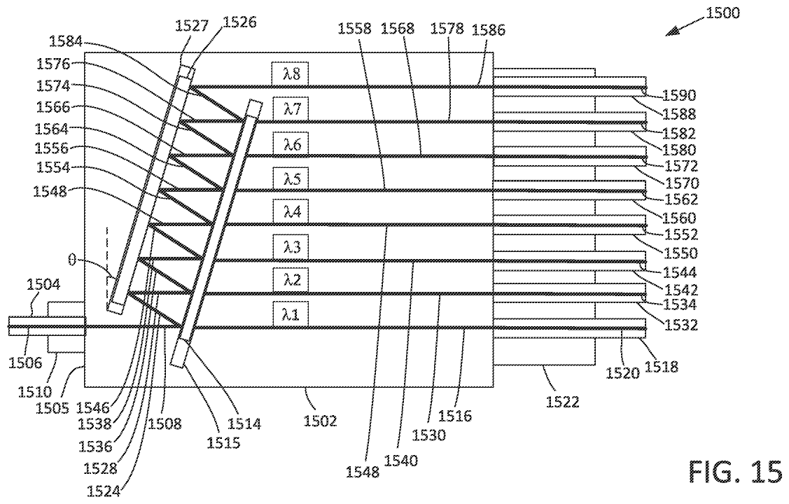

The invention is not limited to four channel WDM mux/demux devices, and the device may have a different number of channels. For example, the mux/demux device may have 8, 12, 16 or more channels. FIG. 15 schematically illustrates an embodiment of an in-line, integrated eight channel WDM mux/demux unit 1500 that handles optical signals having components at up to eight different wavelengths, λ1, λ2, λ3, λ4, λ5, λ6, λ7, and λ8. Additionally, in this embodiment, the broadband reflector is not located at an outer edge of the substrate but is instead located in a slot, or gap, in the substrate. The wavelength selective filter unit and the broadband reflector are oriented at an angle relative to the input edge of the device where the common port is located, which permits the device to be manufactured with straight waveguides.

The mux/demux unit 1500 includes a substrate 1502, which may be formed from a glass, such as silica, from a semiconductor such as silicon, or a polymer. A common fiber 1504 carries a combined optical signal, having components at up to eight different wavelengths, λ1, λ2, λ3, λ4, λ5, λ6, λ7, and λ8. The common fiber 1504 has a core 1506 that is aligned to a common waveguide 1508 on the substrate 1502 so that the combined optical signal may couple between the core 1506 and the common waveguide 1508. The common fiber 1504 and the common waveguide 1508 carry all the wavelength components of the WDM signal entering or leaving the WDM mux/demux unit 1500. The common fiber 1504 may be aligned to the common waveguide 908 using any suitable method, for example using a first alignment block 1510. The substrate 1502 may be described as having a common port where light from the common fiber 1504 enters the common waveguide 1508.

The common waveguide 1508 carries the combined optical signal from the common fiber 1504 to a wavelength selective filter unit 1514 located in a first gap 1515. It should be understood that the device 1500 may be supplied with individual wavelength selective filters rather than a wavelength selective filter unit 1514. The optical signal from the common waveguide 1508 is incident at a position of the wavelength selective filter unit 1514 that transmits the signal component at λ1 to a first separated wavelength waveguide 1516. The signal at λ1 is transported along the first separated wavelength waveguide 1516 to the first separated wavelength fiber 1518. The first separated wavelength fiber 1518 may have a core 1520 aligned to the first separated wavelength waveguide 1516 via a second alignment block 1522. The substrate 1502 may be described as having a first separated wavelength port where light exits the first separated wavelength waveguide 1516 to the core 1520 of the first separated wavelength fiber 1518.

The remainder of the optical signal, with components at λ2, λ3, λ4, λ5, λ6, λ7, and λ8, is reflected by the wavelength selective filter unit 1514 along a first waveguide 1524 to a reflector 1526 located in a second gap 1527. The reflector 1526 may be a broadband reflector, for example a reflecting multilayer stack or a metallic layer on a substrate. The substrate may be a polymer, glass, ceramic or metal. In another embodiment, the reflector 1526 may simply be a polished metallic substrate. In this embodiment, first gap 1515 and the second gap 1527 are parallel and set at an angle, θ, relative to the input edge 705, where 0°<θ<90°. In some embodiments θ≤60° and in others θ≤45°.

The signal containing wavelength components at λ2, λ3, λ4, λ5, λ6, λ7, and λ8 is reflected by the reflector 1526 along a second waveguide 1528 to a point on the wavelength selective filter unit 1514 that transmits light at λ2 to a second separated wavelength waveguide 1530. The signal component at λ2 is transported to a second separated wavelength fiber 1532. The second separated wavelength fiber 1532 may be aligned to the second separated wavelength waveguide 1530 via the alignment block 1522. The substrate 1502 may be described as having a second separated wavelength port where light exits the second separated wavelength waveguide 1530 to the core 1534 of the second separated wavelength fiber 1532.

The remainder of the optical signal, with components at λ3, λ4, λ5, λ6, λ7, and λ8, is reflected by the wavelength selective filter unit 1514 along a third waveguide 1536 to the reflector 1526, where it is reflected along a fourth waveguide 1538 to a point on the wavelength selective filter unit 1514 that transmits light at λ3 to a third separated wavelength waveguide 1540. The optical signal at λ3 is transmitted to a third separated wavelength fiber 1542. The third separated wavelength fiber 1542 may be aligned to the third separated wavelength waveguide 1540 via the alignment block 1522. The substrate 1502 may be described as having a third separated wavelength port where light exits the third separated wavelength waveguide 1540 to the core 1544 of the third separated wavelength fiber 1542.

The remainder of the optical signal, with components at λ4, λ5, λ6, λ7, and λ8, is reflected by the wavelength selective filter unit 914 along a fifth waveguide 946 to the reflector 926, where it is reflected along a sixth waveguide 948 to a point on the wavelength selective filter unit 914 that transmits light at λ4 to a fourth separated wavelength waveguide 948. The optical signal at λ3 is transmitted to a fourth separated wavelength fiber 950. The fourth separated wavelength fiber 950 may be aligned to the fourth separated wavelength waveguide 948 via the alignment block 922. The substrate 902 may be described as having a fourth separated wavelength port where light exits the fourth separated wavelength waveguide 948 to the core 952 of the fourth separated wavelength fiber 950.

The remainder of the optical signal, with components at λ5, λ6, λ7, and λ8, is reflected by the wavelength selective filter unit 914 along a seventh waveguide 954 to the reflector 926, where it is reflected along an eighth waveguide 956 to a point on the wavelength selective filter unit 914 that transmits light at λ5 to a fifth separated wavelength waveguide 958. The optical signal at λ5 is transmitted to a fifth separated wavelength fiber 960. The fifth separated wavelength fiber 960 may be aligned to the fifth separated wavelength waveguide 958 via the alignment block 922. The substrate 902 may be described as having a fifth separated wavelength port where light exits the fifth separated wavelength waveguide 958 to the core 962 of the fifth separated wavelength fiber 960.

The remainder of the optical signal, with components at λ6, λ7, and λ8, is reflected by the wavelength selective filter unit 1514 along a ninth waveguide 1564 to the reflector 1526, where it is reflected along a tenth waveguide 1566 to a point on the wavelength selective filter unit 1514 that transmits light at λ6 to a sixth separated wavelength waveguide 1568. The optical signal at λ6 is transmitted to a sixth separated wavelength fiber 1570. The sixth separated wavelength fiber 1570 may be aligned to the sixth separated wavelength waveguide 1558 via the alignment block 1522. The substrate 1502 may be described as having a sixth separated wavelength port where light exits the sixth separated wavelength waveguide 1568 to the core 1572 of the sixth separated wavelength fiber 1570.

The remainder of the optical signal, with components at λ7 and λ8, is reflected by the wavelength selective filter unit 1514 along an eleventh waveguide 1574 to the reflector 1526, where it is reflected along a twelfth waveguide 1576 to a point on the wavelength selective filter unit 1514 that transmits light at λ7 to a seventh separated wavelength waveguide 1578. The optical signal at λ7 is transmitted to a seventh separated wavelength fiber 1580. The seventh separated wavelength fiber 1580 may be aligned to the seventh separated wavelength waveguide 1568 via the alignment block 1522. The substrate 1502 may be described as having a seventh separated wavelength port where light exits the seventh separated wavelength waveguide 1578 to the core 1582 of the seventh separated wavelength fiber 1580.

The remainder of the optical signal, with a component at λ8, is reflected by the wavelength selective filter unit 1514 along a thirteenth waveguide 1584 to the reflector 1526, where it is reflected along an eighth separated wavelength waveguide 1586 to a seventh separated wavelength fiber 1588. The eighth separated wavelength fiber 1588 may be aligned to the eighth separated wavelength waveguide 1586 via the alignment block 1522. The substrate 1502 may be described as having an eighth separated wavelength port where light exits the eighth separated wavelength waveguide 1586 to the core 1590 of the eighth separated wavelength fiber 1588.

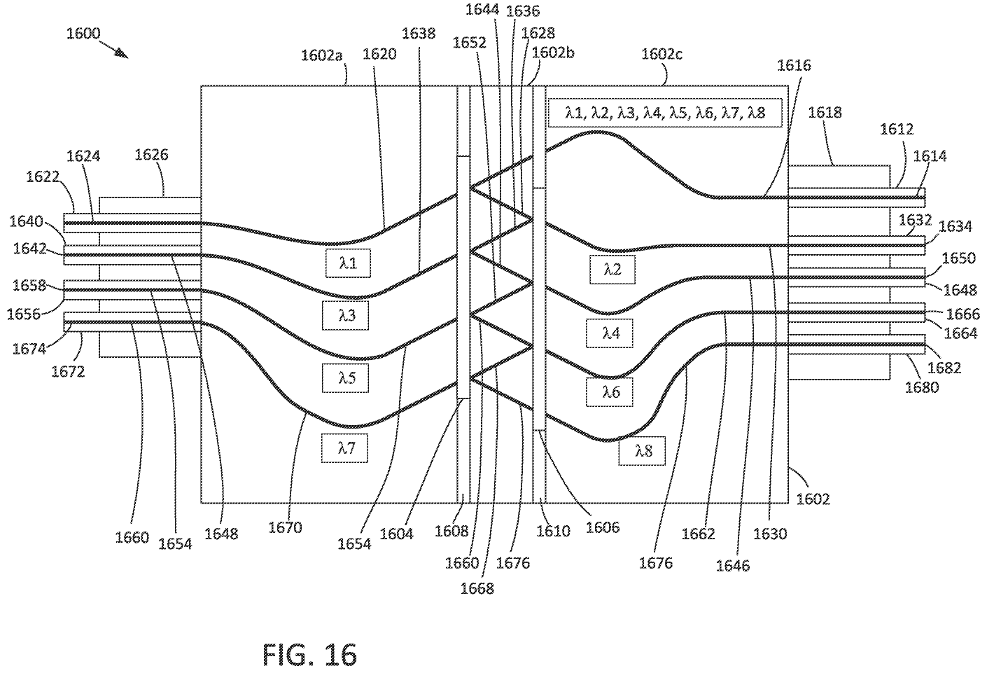

Another embodiment of eight channel WDM mux/demux unit 1600, having a hybrid configuration, is schematically illustrated in FIG. 16. In the illustrated hybrid configuration, the common optical signal enters from the same first side as some of the separated wavelength fibers, while others of the separated wavelength fibers are on a different, second side of the unit. In the illustrated embodiment, the common optical signal enters from a first side of the mux/demux unit 1600 that is opposite the second side. The illustrated embodiment is an eight-channel mux/demux unit 1600, operating with eight signal components having wavelengths λ1, λ2, λ3, λ4, λ5, λ6, λ7, and λ8. However, it will be appreciated that the mux/demux unit 1600 may be adapted for different numbers of wavelength components, and also may be adapted so that some of the separated wavelength fibers may also enter the unit 1600 at a third side.

The mux/demux unit 1600 includes a first substrate 1602 that is described as having three sections. A first section 1602a positioned generally to the left of a first filter unit 1604, a second section 1602b is generally between the first filter unit 1604 and a second filter unit 1606 and a third section 1602c is generally to the right of the second filter unit 1606. The first and second filter unit 1604, 1606 may be parallel to one another. The first substrate 1602 may be formed from a single substrate, or from substrate sections that are bonded together. The first filter unit 1604 is located in a first gap 1608 between the first and second substrate sections 1602a, 1602b. The first gap 1608 may extend across the entire width of the substrate 1602, for example as a groove cut across the substrate 1602, or may result from the first substrate section 1602a and the second substrate section 1602b being bonded together with the first filter unit 1604 therebetween. The first gap 1608 may also extend over only part of the substrate 1602 width, for example in the form of an etched well. The first filter unit 1604 may be bonded within the first gap 1608 using an adhesive. Portions of the first gap 1608 that lie outside the lateral extent of the first filter unit 1604 may be filled with adhesive.

Likewise, the second filter unit 1606 is located in a second gap 1610 between the second and third substrate sections 1602b, 1602c. The second gap 1610 may extend across the entire width of the substrate 1602, for example as a groove cut across the substrate 1602, or may result from the second substrate section 1602b and the third substrate section 1602c being bonded together with the second filter unit 1606 therebetween. The second gap 1610 may also extend over only part of the width of the substrate 1602, for example in the form of an etched well. The second filter unit 1606 may be bonded within the second gap 1610 using an adhesive. Portions of the second gap 1610 that lie outside the lateral extent of the second filter unit 1606 may be filled with adhesive.

A common fiber 1612 carries a combined optical signal, having components at eight different wavelengths, λ1, λ2, λ3, λ4, λ5, λ6, λ7, λ8. The common fiber 1612 has a core 1614 that is aligned to a common waveguide 1616 in the third substrate section 1602c so that the combined optical signal may couple between the core 1614 and the common waveguide 1616. The common fiber 1612 may aligned to the common waveguide 1616 using any suitable method. For example, the common fiber 1612 may be aligned using an alignment block 1618, such as a v-groove alignment block, although other shapes of groove may also be used.

The common waveguide 1616 carries the combined optical signal to the first filter unit 1604. The common waveguide 1616 may cross the second gap 1610 between the second and third substrate sections 1602b, 1602c. The combined optical signal propagating along the common waveguide 1616 is incident at the first filter unit 1604 at a point where the first filter unit 1604 transmits light at λ1. Accordingly, the optical signal component at λ1 is transmitted through the first filter unit 1604 to a first separated wavelength waveguide 1620 and is transported to the first separated wavelength fiber 1622. The core 1624 of the first separated wavelength fiber 1622 may be aligned to the first separated wavelength waveguide 1620 via another alignment block 1626.

The remainder of the optical signal, with components at λ2, λ3, λ4, λ5, λ6, λ7, and λ8, is reflected by the first filter unit 1604 along a first waveguide 1628 to the second filter unit 1606. The optical signal propagating along the first waveguide 1628 is incident at the second filter unit 1606 at a point where the second filter unit 1606 transmits light at) λ2. Accordingly, the optical signal component at λ2 is transmitted through the second filter unit 1606 to a second separated wavelength waveguide 1630 and is transported to a second separated wavelength fiber 1632. The core 1634 of the second separated wavelength fiber 1632 may be aligned to the second separated wavelength waveguide 1630 using any suitable method. In the illustrated embodiment, the second separated wavelength fiber 1632 is aligned using the first alignment block 1618.

The first and second filter units 1604, 1606 may include filter cassettes or LVFs or, in other embodiments, may be substituted by individual wavelength selective filters.

The remainder of the optical signal, with components at λ3, λ4, λ5, λ6, λ7, and) λ8, is reflected by the second filter unit 1606 along a second waveguide 1636 to the first filter unit 1604. The optical signal propagating along the second waveguide 1636 is incident at the first filter unit 1604 at a point where the first filter unit 1604 transmits light at λ3. Accordingly, the optical signal component at λ3 is transmitted through the first filter unit 1604 to a third separated wavelength waveguide 1638 and is transported to a third separated wavelength fiber 1640. The core 1642 of the third separated wavelength fiber 1640 may be aligned to the third separated wavelength waveguide 1638 using any suitable method. In the illustrated embodiment, the third separated wavelength fiber 1640 is aligned using the second alignment block 1626.

The remainder of the optical signal, with components at λ4, λ5, λ6, λ7, and λ8, is reflected by the first filter unit 1604 along a third waveguide 1644 to the second filter unit 1606. The optical signal propagating along the third waveguide 1644 is incident at the second filter unit 1606 at a point where the second filter unit 1606 transmits light at λ4. Accordingly, the optical signal component at λ4 is transmitted through the second filter unit 1606 to a fourth separated wavelength waveguide 1646 and is transported to a fourth separated wavelength fiber 1648. The core 1650 of the fourth separated wavelength fiber 1648 may be aligned to the fourth separated wavelength waveguide 1646 using any suitable method, for example using the first alignment block 1618.

The remainder of the optical signal, with components at λ5, λ6, λ7, and λ8, is reflected by the second filter unit 1606 along a fourth waveguide 1652 to the first filter unit 1604. The optical signal propagating along the fourth waveguide 1652 is incident at the first filter unit 1604 at a point where the first filter unit 1604 transmits light at λ5. Accordingly, the optical signal component at is transmitted through the first filter unit 1604 to a fifth separated wavelength waveguide 1654 and is transported to a fifth separated wavelength fiber 1656. The core 1658 of the fifth separated wavelength fiber 1656 may be aligned to the fifth separated wavelength waveguide 1654 using any suitable method, for example, using the second alignment block 1626.

The remainder of the optical signal, with components at λ6, λ7, and λ8, is reflected by the first filter unit 1604 along a fifth waveguide 1660 to the second filter unit 1606. The optical signal propagating along the fifth waveguide 1660 is incident at the second filter unit 1606 at a point where the second filter unit 1606 transmits light at λ6. Accordingly, the optical signal component at λ6 is transmitted through the second filter unit 1606 to a sixth separated wavelength waveguide 1662 and is transported to a sixth separated wavelength fiber 1664. The core 1666 of the sixth separated wavelength fiber 1664 may be aligned to the sixth separated wavelength waveguide 1662 using any suitable method, for example using the first alignment block 1618.

The remainder of the optical signal, with components at λ7 and λ8, is reflected by the second filter unit 1606 along a sixth waveguide 1668 to the first filter unit 1604. The optical signal propagating along the sixth waveguide 1668 is incident at the first filter unit 1604 at a point where the first filter unit 1604 transmits light at λ7. Accordingly, the optical signal component at λ7 is transmitted through the first filter unit 1604 to a seventh separated wavelength waveguide 1670 and is transported to a seventh separated wavelength fiber 1672. The core 1674 of the seventh separated wavelength fiber 1672 may be aligned to the seventh separated wavelength waveguide 1670 using any suitable method, for example, using the second alignment block 1626.

The remainder of the optical signal, with a component at λ8, is reflected by the first filter unit 1604 along an eighth separated wavelength waveguide 1676 to the second filter unit 1606. In some embodiments the optical signal propagating along the eighth separated wavelength waveguide 1676 is incident at the second filter unit 1606 at a point where the second filter unit 1606 transmits light at λ8, in which case the optical signal component at λ8 is transmitted through the second filter unit 1606 to so as to continue to propagate along a section of the eighth separated wavelength waveguide 1676 in the third substrate section 1602c and is transported to an eighth separated wavelength fiber 1680. The core 1682 of the eighth separated wavelength fiber 1680 may be aligned to the eighth separated wavelength waveguide 1676 using any suitable method, for example using the first alignment block 1618. In other embodiments the second filter unit 1606 does not extend to that portion of the second gap 1610 where the eighth separated wavelength waveguide 1676 in the second substrate section 1602b is incident. In such a case, light at λ8 propagates along the eighth separated wavelength waveguide 1676 from the second substrate section 1602b, across the gap second 1610 to the third waveguide section 1602c.

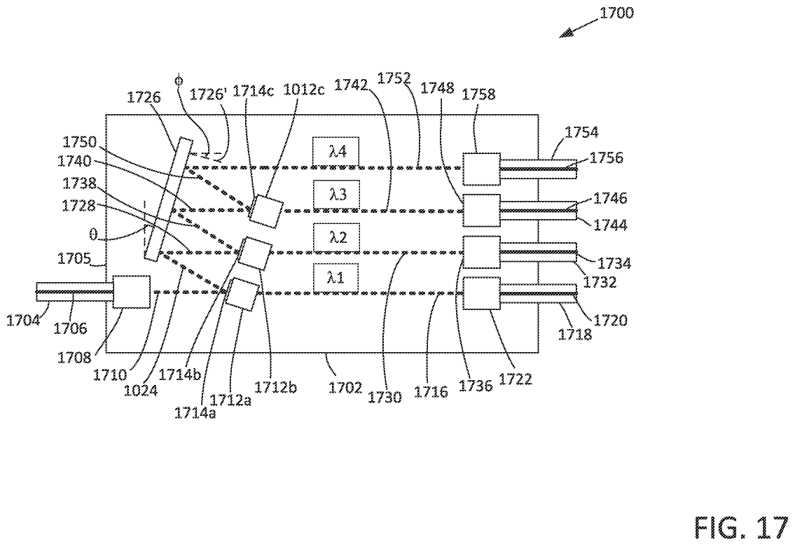

Free-space propagation approaches may also be used to provide an in-line WDM mux/demux device. One embodiment of a free-space propagation, four channel in-line WDM mux/demux device 1700, that handles optical signals having components of up to four different wavelengths, λ1, λ2, λ3, λ4, is schematically illustrated in FIG. 17. In this approach the optical components, such as fibers, lenses, filters and reflector, are mounted on a substrate 1702 and the optical signals propagate between the common fiber and the separated wavelength fibers in free space. The substrate 1702 may be formed from a glass, such as silica glass, a semiconductor such as silicon or a III-V semiconductor, a polymer, a metal, a ceramic or the like. Unlike the integrated embodiments discussed above, the substrate 1702 only provides mechanical support for the components and its optical properties are not important, as no light passes through the substrate 1702. Each element mounted to the substrate 1702 may be located in a respective recess that is fabricated on the surface of the substrate that positions and orients the element.

A common fiber 1704 carries a combined optical signal, having components of up to four different wavelengths, λ1, λ2, λ3, λ4. The common fiber 1704 has a fiber core 1706 and is terminated with a common GRIN lens 1708, preferably with the axis of the common GRIN lens 1708 aligned with the fiber core 1706. The pitch of the common GRIN lens 1708 is selected such light that propagates out of the common GRIN lens 1708 from the fiber core is effectively collimated and may be, for example, a quarter pitch GRIN lens. The common fiber 1704 and the common GRIN lens 1708 carry all the wavelength components of the WDM signal entering or leaving the WDM mux/demux unit 1700. The device 1700 may be described as having a common port where light passes from the common fiber 1704 into the common GRIN lens 1708 or from the common GRIN lens 1708 into the common fiber 1704. The common GRIN lens 1704 and common fiber 1702 are attached to the substrate, for example using an optical adhesive.

The common optical signal propagates in free space along a common optical path 1710, shown in dotted line, to a first frequency selective filter 1714a. The first wavelength selective filter 1714a transmits light at one wavelength, or wavelength group, for example λ1, while reflecting light at other wavelengths, or wavelength groups. The first wavelength selective filter 1714a may be mounted directly to the substrate 1702 or may be mounted to a first filter substrate 1712a that is mounted on the substrate 1702. The first filter substrate 1712a may be used to provide support to the first wavelength selective filter 1714a if the filter 1714a itself is not self-supporting. The first filter substrate 1712a is preferably formed of a material that is transparent at λ1 so as to reduce optical losses. The component optical signal at λ1 is transmitted from the first wavelength selective filter 1714a along a first separated wavelength path 1716 to a first separated wavelength fiber 1718 that has a core 1720. The first separated wavelength fiber 1718 is terminated with a first GRIN lens 1722 to focus the optical signal component at λ1 into the core 1720. Where the first separated optical path 1716 is substantially collimated, the first GRIN lens 1722 may have a pitch of around a quarter. The first separated wavelength fiber 1718 and the first GRIN lens 1722 are mounted to the substrate 1702.

The remainder of the optical signal, with components at λ2, λ3, and λ4, is reflected by the wavelength selective filter 1714a along a first path 1724 to a reflector 1726 mounted on the substrate 1702. The reflector 1726 may be any suitable reflecting element that effectively reflects light at the wavelengths λ2, λ3, λ4. For example, the reflector 1726 may include a reflective coating on a reflector substrate, such as a multilayer dielectric reflector coating or metal coating, that is mounted to the substrate 1702. In other approaches the reflector 1726 may be a polished metal substrate mounted to the substrate 1702 The reflector 1726 may be referred to as a broadband reflector as it is capable of reflecting multiple wavelength components of the optical signal.

The signal containing wavelengths λ2, λ3, λ4 is reflected by the reflector 1726 along a second path 1728 to a second wavelength selective filter 1714b, which may be mounted on a second filter substrate 1712b. The second wavelength selective filter 1714b or the second filter substrate 1712b is mounted to the substrate 1702. The reflecting surface of the reflector 1726 is at an angle, θ, relative to the input edge 1705 of the substrate 1702, where 0°<θ<90°. In some embodiments θ≤60° and in others θ≤45°. In some embodiments, θ≥5°, θ≥17° in others and θ≥20° in other embodiments. Also, a normal 1726′ to the reflector 1726 forms an angle φ relative to the common optical path 1710. Where the common optical path 1710 is perpendicular to the input edge 1705, θ=φ

The reflector 1726 and first wavelength selective filter 1714a may be set with their reflecting faces parallel to one another, such that the second path 1728 is parallel to the common path 1710. Parallel reflecting surfaces means that the reflecting surfaces of the reflector 1726 and the first wavelength selective filter 1714a are parallel to within less than 5° of each other, preferably within less than 2° and more preferably within less than 1°. The second wavelength selective filter 1714b transmits the component optical signal at λ2 along a second separated wavelength path 1730 to a second separated wavelength fiber 1732 that has a core 1734. The second separated wavelength fiber 1732 is terminated with a second GRIN lens 1736 to focus the optical signal component at λ2 into the core 1734. Where the second separated optical path 1730 is substantially collimated, the second GRIN lens 1736 may have a pitch of around a quarter. The second separated wavelength fiber 1732 and the second GRIN lens 1736 are mounted to the substrate 1702.

The remainder of the optical signal, with components at λ3 and λ4, is reflected by the second wavelength selective filter 1714b along a third path 1738 to the reflector 1726, where it is reflected along a fourth path 1740 to a third wavelength selective filter 1714c, which may be mounted on a third filter substrate 1712c. The third wavelength selective filter 1714c or the third filter substrate 1712s is mounted to the substrate 1702. The reflecting surface of the third wavelength selective filter 1714c may be set parallel with the reflecting surface of the reflector 1726.

The third wavelength selective filter 1714c transmits the component optical signal at λ3 along a third separated wavelength path 1742 to a third separated wavelength fiber 1744 that has a core 1746. The third separated wavelength fiber 1744 is terminated with a third GRIN lens 1748 to focus the optical signal component at λ3 into the core 1746. Where the third separated optical path 1742 is substantially collimated, the third GRIN lens 1748 may have a pitch of around a quarter. The third separated wavelength fiber 1744 and the third GRIN lens 1748 are mounted to the substrate 1702.

The remainder of the optical signal, with a components at λ4, is reflected by the third wavelength selective filter 1714c along a fifth path 1750 to the reflector 1726, where it is reflected along a fourth separated wavelength path 1752 to a fourth separated wavelength fiber 1754 that has a core 1756. The fourth separated wavelength fiber 1754 is terminated with a fourth GRIN lens 1758 to focus the optical signal component at 24 into the core 1756. The fourth separated wavelength fiber 1754 and the fourth GRIN lens 1758 are mounted to the substrate 1702.

Where the fourth separated optical path 1752 is substantially collimated, the fourth GRIN lens 1758 may have a pitch of around one quarter. The first, second, third and fourth GRIN lenses 1722, 1736, 1748, 1758 need not, however, all have the same pitch and may have different pitches. For example, the pitch of the fourth GRIN lens 1758 may be longer than the pitch of the first GRIN lens 1722 to compensate for increased divergence, if present, of the light received at the fourth GRIN lens 1758 from the common GRIN lens 1708 compared to that of the light received at the first GRIN lens 1722 from the common GRIN lens 1708.

While the free space propagation mux/demux device 1700 was described as using GRIN lenses for coupling light to and from fiber cores, this is not a necessary requirement and the GRIN lenses could be replaced by conventional lenses having curved surfaces. GRIN lenses may be preferred in some situations however, because they provide a flat surface for physically coupling directly to a fiber end face.

In one approach to fabricating the device 1700, each filter 1714a-c and the corrective optical elements, e.g. lenses, may be placed on the substrate while performing an in situ measurement to determine optimal positions and orientations. For example, after placing the common fiber 1704, the common fiber lens 1708 and the first wavelength selective filter 1714a, the positions for the first separated wavelength fiber 1718 and lens 1722 may be obtained experimentally by optimizing the signal at the first wavelength through the first separated wavelength fiber 1718. Likewise, after the reflector 1726 has been positioned, the second wavelength selective filter 1714b and second separated wavelength fiber 1732 and lens 1736 may be positioned, and so on.

It will be appreciated that the individual wavelength selective filters 1714a-c may be replaced by a wavelength selective filter unit, which may comprise individual wavelength selective filters mounted to a filter unit substrate, may comprise an LVF, or may comprise a number of filters each transmissive at a selected wavelength.

The description of WDM mux/demux devices provided above generally describes optical signals propagating through the device from the common input/output and out of the device at the separated wavelength ports. This was done merely to facilitate describing the devices, and there is no intention to limit the device to having optical signals to propagating in only this one direction, from common port to separated wavelength ports. Optical signals may also propagate in the opposite direction, from the separated wavelength ports to the common port, in which case separate wavelength signals are combined at the reflective filters to form a common signal. In some embodiments, there may be optical signals propagating in both directions through a WDM mux/demux device of the present invention.

Various modifications, equivalent processes, as well as numerous structures to which the present invention may be applicable will be readily apparent to those of skill in the art to which the present invention is directed upon review of the present specification. The claims are intended to cover such modifications and devices. For example, the mux/demux devices described herein may be modified to carry more or fewer separated wavelength optical channels than described here. For example, the WDM mux/demux devices 800, 900, 1000, 1100, 1400, 1500, 1600, and 1700 may be adapted to include a larger or small number of channels. For example, devices 800, 900, 1000, 1100, 1400, and 1700 may be adapted to include 8, 12 or 16 channels. Additionally, it should be understood that the mux/demux devices of the present invention are operable without all signal components being present. For example, in a four channel device capable of operating at signal component wavelengths of λ1, λ2, λ3, and λ4, the optical signal component at λ3 may be missing without affecting the ability of the device to multiplex and demultiplex the signal components at the other wavelengths.

As noted above, the present invention is applicable to fiber optical communication and data transmission systems. Accordingly, the present invention should not be considered limited to the particular examples described above, but rather should be understood to cover all aspects of the invention as fairly set out in the attached claims.

1-38. (canceled)

39. An optical device, comprising:
a substrate;
a first linear variable filter (LVF) having a transmission wavelength that is dependent on position along the first LVF, the first LVF being mounted in a gap in the substrate;
a common waveguided optical path on the substrate to guide a common optical signal having components at a plurality of wavelengths from an input of the substrate to a first position on the first LVF;
a first separated wavelength waveguided optical path on the substrate to guide light transmitted through the first LVF at the first position on the first LVF to a first separated wavelength output;
a first waveguided optical path on the substrate to guide light reflected from the first position on the first LVF to a second position on the first LVF; and
a second separated wavelength waveguided optical path on the substrate to guide light transmitted through the first LVF at the second position on the first LVF to a second separated wavelength output.

40. The optical device as recited in claim 39, the first waveguided optical path comprising a first waveguide, a reflecting element and a second waveguide.

41. The optical device as recited in claim 40, wherein the reflecting element is a broadband reflector.

42. The optical device as recited in claim 40, wherein the reflecting element is a second LVF having a second face facing a first face of the first LVF, the first waveguided optical path being incident at a first position on the second LVF.

43. The optical device as recited in claim 42, further comprising a third separated wavelength waveguided optical path on the substrate to guide light transmitted through the second LVF at the first position on the second LVF to a third separated wavelength output.

44. The optical device as recited in claim 43, further comprising a common optical fiber having a core aligned with the common waveguided optical path at the input of the substrate, a first separated wavelength optical fiber having core aligned with the first separated wavelength waveguided optical path at the first separated wavelength output, and a second separated wavelength optical fiber having core aligned with the second separated wavelength waveguided optical path at the second separated wavelength output.

45. The optical device as recited in claim 39, wherein the input of the substrate, the first separated wavelength output and the second separated wavelength output are located at a first side of the substrate.

46. The optical device as recited in claim 39, wherein the input of the substrate is located at a first side of the substrate and the first separated wavelength output and the second separated wavelength output are located at a second side of the substrate different from the first side of the substrate.

47. The optical device as recited in claim 39, wherein at least one of the common waveguide optical path, the first waveguided optical path, the first separated wavelength optical path, and second separated wavelength optical path has an end provided with an expanded core.

48. The optical device as recited in claim 39, wherein the gap is a well in the substrate.

49. The optical device as recited in claim 39, wherein the gap is a groove across the substrate.

50. The optical device as recited in claim 39, wherein the substrate comprises a first substrate section having a first edge and a second substrate section having a second edge facing the first edge of the first substrate section, the gap being formed by the first edge of the first substrate section and the second edge of the second substrate section.

51. An optical device, comprising:
a substrate;
a first linear variable filter (LVF) having a transmission wavelength that is dependent on position along the first LVF, the first LVF being mounted in a first gap of the first substrate, the first LVF having a first face;
a second LVF having a transmission wavelength that is dependent on position along the second LVF, the second LVF being mounted in a second gap of the substrate, the second LVF having a second face facing the first face of the first LVF;
a common waveguided optical path on the substrate for guiding a common optical signal having components at a plurality of wavelengths from an input of the common waveguided optical path to be incident on the first face of the first LVF, at a first position on the first LVF;
a first waveguide on the substrate having a first end disposed to receive light from the common waveguide that is reflected at the first face at the first position of the first LVF, the first waveguide having a second end proximate a first position on the second LVF; and
a second waveguide on the substrate having a first end disposed to receive light from the first waveguide that is reflected at the second face at the first position of the second LVF, the second waveguide having a second end proximate a second position on the first LVF.

52. The optical device as recited in claim 51, further comprising a first separated wavelength waveguide having a first end disposed proximate the first position of the first LVF to receive light at a first wavelength transmitted through the first position of the first LVF, and a second separated wavelength waveguide having a first end disposed proximate the first position of the second LVF to receive light at a second wavelength transmitted through the first position of the second LVF.

53. The optical device as recited in claim 52, further comprising a common optical fiber coupled to the input of the common waveguided optical path, a first separated wavelength optical fiber coupled to an output of the first separated wavelength waveguide and a second separated wavelength optical fiber coupled to an output of the second separated wavelength waveguide.

54. The optical device as recited in claim 51, further comprising a third waveguide on the having a first end disposed to receive light from the second waveguide that is reflected at the first face at a second position of the first LVF, the third waveguide having a second end proximate a second position on the second LVF.

55. The optical device as recited in claim 51, wherein at least one of the first end of the first waveguide, the second end of the first waveguide, the first end of the second waveguide and the second end of the second waveguide is provided with an expanded core.

56. The optical device as recited in claim 51, wherein the first gap is a first well in the substrate and the second gap is a second well in the substrate.

57. The optical device as recited in claim 51, wherein the first gap is a first groove across the substrate and the second gap is second groove across the first substrate.

58. The optical device as recited in claim 51, wherein the substrate comprises a first substrate section having a first edge and a second substrate section having a second edge facing the first edge of the first substrate section, the first gap being formed by the first edge of the first substrate section and the second edge of the second substrate section and wherein the substrate further comprises a third substrate section having a third edge facing a fourth edge of the second substrate section, the second gap being formed by the third edge of the third substrate section and the fourth edge of the second substrate section.

59-76. (canceled)
